(19) United States
(12) Patent Application Publication
(10) Pub. No.: US 2023/0418346 A1
(43) Pub. Date: Dec. 28, 2023

(54) METHODS, SYSTEMS, AND MEDIA FOR AUTOMATIC AND CONTINUOUS CONTROL OF ENERGY-CONSUMING DEVICES

(71) Applicant: Google LLC, Mountain View, CA (US)

(72) Inventors: Charlotte Matthews, New York, NY (US); Rebecca A. Craft, New York, NY (US); Stuart Bridgett, New York, NY (US); Anne Shellum, New York, NY (US); Rajesh Menon, New York, NY (US)

(21) Appl. No.: 17/848,125

(22) Filed: Jun. 23, 2022

(51) Int. Cl. G06F 1/26

(52) U.S. Cl. CPC G06F 1/26

(57) ABSTRACT

Methods, systems, and media for automatic and continuous control of energy-consuming devices are provided. In some embodiments, the method comprises: determining, using a hardware processor, connected devices from a plurality of devices that are eligible for automatic control, wherein the plurality of devices are connected to a communications network; determining, using the hardware processor, available actions for each of the connected devices; generating, using the hardware processor, a plurality of automatic control actions for at least a portion of the connected devices based at least in part on a dynamic rate of electricity generated by a dynamic rate engine and an energy mode selected by a user in an application, wherein the plurality of automatic control actions are based on the available actions for each connected device; causing, using the hardware processor, a user interface to be presented in an application that indicates the plurality of automatic control actions for transmission to the portion of the connected devices, wherein the user interface provides a user interface element for overriding one or more of the plurality of automatic control actions; in response to determining that the user interface element for overriding one or more of the plurality of automatic control actions has not been selected by the user of the application, transmitting, using the hardware processor, a first subset of the plurality of automatic control actions to one or more communication gateways that are each connected to at least one of the subset of connected devices and a second subset of the plurality of automatic control actions directly to a subset of the connected devices via a device cloud platform; and updating, using the hardware processor, the user interface to indicate that at least one of the first subset of the plurality of automatic control actions and the second subset of the plurality of automatic control actions have been performed on the portion of the connected devices and energy usage savings from the performance of the automatic control actions.

### TECHNICAL FIELD

The disclosed subject matter relates to methods, systems, and media for automatic and continuous control of energy-consuming devices. More particularly, the disclosed subject matter relates to approaches for energy management that may include (i) a home scheduler system that autonomously manages energy-consuming systems and devices in a home of a residential user based on a comfort mode, energy budget, and/or solar and/or battery shares, (ii) a dynamic rate engine that dynamically determines an energy price based on the changing wholesale price of electricity and based on a capacity cost, (iii) an electronic billing system that interfaces with the home scheduler system and the dynamic rate engine to generate a customized bill for the residential user, and/or (iv) a solar and battery transaction system that recommends the acquisition of solar and/or battery shares of community-sited solar and battery capacity for the residential user.

### BACKGROUND

To address climate change, utility providers are replacing fossil fuel plants with renewable power and accelerating electrification. Greening the grid, however, creates new challenges. As such, residents may face higher overall energy costs, and utility providers need ways to harness clean, low-cost power produced during off-peak periods.

Accordingly, it is desirable to provide new methods, systems, and media for automatic and continuous control of energy-consuming devices.

### SUMMARY

Methods, systems, and media for automatic and continuous control of energy-consuming devices are provided.

In accordance with some embodiments of the disclosed subject matter, a method for energy management is provided, the method comprising: determining, using a hardware processor, connected devices from a plurality of devices that are eligible for automatic control, wherein the plurality of devices are connected to a communications network; determining, using the hardware processor, available actions for each of the connected devices; generating, using the hardware processor, a plurality of automatic control actions for at least a portion of the connected devices based at least in part on a dynamic rate of electricity generated by a dynamic rate engine and an energy mode selected by a user in an application, wherein the plurality of automatic control actions are based on the available actions for each connected device; causing, using the hardware processor, a user interface to be presented in an application that indicates the plurality of automatic control actions for transmission to the portion of the connected devices, wherein the user interface provides a user interface element for overriding one or more of the plurality of automatic control actions; in response to determining that the user interface element for overriding one or more of the plurality of automatic control actions has not been selected by the user of the application, transmitting, using the hardware processor, a first subset of the plurality of automatic control actions to one or more communication gateways that are each connected to at least one of the subset of connected devices and a second subset of the plurality of automatic control actions directly to a subset of the connected devices via a device cloud platform; and updating, using the hardware processor, the user interface to indicate that at least one of the first subset of the plurality of automatic control actions and the second subset of the plurality of automatic control actions have been performed on the portion of the connected devices and energy usage savings from the performance of the automatic control actions.

In some embodiments, the subset of connected devices is determined to be eligible for automatic control based on an operation mode selected by the user in the application and based on a device status associated with each of the plurality of devices.

In some embodiments, the subset of connected devices is determined to be eligible for automatic control by comparing the dynamic rate of electricity generated by the dynamic rate engine with a threshold value.

In some embodiments, the subset of connected devices is determined to be eligible for automatic control based on user preferences that have been inputted by the user into the application.

In some embodiments, the subset of connected devices is determined to be eligible for automatic control based on user preferences that have been learned by a machine learning model associated with the application.

In some embodiments, the subset of connected devices is determined to be eligible for automatic control based on the energy mode selected by the user in the application and based on a comparison of energy usage for a particular time period with a target budget that is associated with the selected energy mode.

In some embodiments, the subset of connected devices is determined to be eligible for automatic control based on an availability of community solar and battery shares.

In some embodiments, the dynamic rate of electricity is generated based on the availability of community solar and battery shares.

In some embodiments, the subset of connected devices is determined to be eligible for automatic control based on a comparison of an actual and forecasted electricity cost for a particular time period with a target budget for the particular time period.

In some embodiments, the subset of connected devices is determined to be eligible for automatic control based on the number of device control actions issued for each of the subset of connected devices.

In some embodiments, the dynamic rate engine determines the dynamic rate to incorporate a commodity cost, a transmission, distribution, and administration cost, and a settlement cost, wherein the commodity cost is determined at a particular time interval and is based on historical market data, weather forecast data, and machine learning predictions of energy consumption estimates for each time interval, wherein the transmission, distribution, and administration cost is a share of a total forecasted transmission, distribution, and administration cost for a utility provider, weighted based on forecasted electricity demand for the community, and wherein the settlement cost is proportional to forecasted energy demands for a community that includes the user.

In some embodiments, the plurality of devices are located within a residential home and wherein the method further comprises determining whether the residential home is vacant based on current occupancy information and historical occupancy information.

In some embodiments, the method further comprises determining whether the residential home is vacant based on a vacancy confidence, wherein vacancy confidence level is incrementally increased over time until occupancy of the residential home from the current occupancy information has been confirmed.

In some embodiments, the method further comprises performing a vacancy check in response to determining that the vacancy confidence level has met an actionable vacancy confidence threshold value.

In some embodiments, the method further comprises retrieving an expectation of occupancy value for a current time from a learned occupancy schedule and comparing the expectation of occupancy value for the current time from the learned occupancy schedule against the actionable vacancy confidence threshold value.

In some embodiments, the current occupancy information is captured using an occupancy sensor that is associated with one of the connected devices. In some embodiments, the current occupancy information is captured based on one or more user interactions with one of the connected devices. In some embodiments, the current occupancy information is determined at least in part by transmitting energy usage information into a machine learning system that identifies changes in power consumption that correspond to occupancy of the residential home.

In accordance with some embodiments of the disclosed subject matter, a system for energy management is provided, the system comprising a hardware processor that is configured to: determine connected devices from a plurality of devices that are eligible for automatic control, wherein the plurality of devices are connected to a communications network; determine available actions for each of the connected devices; generate a plurality of automatic control actions for at least a portion of the connected devices based at least in part on a dynamic rate of electricity generated by a dynamic rate engine and an energy mode selected by a user in an application, wherein the plurality of automatic control actions are based on the available actions for each connected device; cause a user interface to be presented in an application that indicates the plurality of automatic control actions for transmission to the portion of the connected devices, wherein the user interface provides a user interface element for overriding one or more of the plurality of automatic control actions; in response to determining that the user interface element for overriding one or more of the plurality of automatic control actions has not been selected by the user of the application, transmit a first subset of the plurality of automatic control actions to one or more communication gateways that are each connected to at least one of the subset of connected devices and a second subset of the plurality of automatic control actions directly to a subset of the connected devices via a device cloud platform; and update the user interface to indicate that at least one of the first subset of the plurality of automatic control actions and the second subset of the plurality of automatic control actions have been performed on the portion of the connected devices and energy usage savings from the performance of the automatic control actions.

In accordance with some embodiments of the disclosed subject matter, a non-transitory computer-readable medium containing computer executable instructions that, when executed by a processor, cause the processor to perform a method for energy management is provided, the method comprising: determining, using a hardware processor, connected devices from a plurality of devices that are eligible for automatic control, wherein the plurality of devices are connected to a communications network; determining, using the hardware processor, available actions for each of the connected devices; generating, using the hardware processor, a plurality of automatic control actions for at least a portion of the connected devices based at least in part on a dynamic rate of electricity generated by a dynamic rate engine and an energy mode selected by a user in an application, wherein the plurality of automatic control actions are based on the available actions for each connected device; causing, using the hardware processor, a user interface to be presented in an application that indicates the plurality of automatic control actions for transmission to the portion of the connected devices, wherein the user interface provides a user interface element for overriding one or more of the plurality of automatic control actions; in response to determining that the user interface element for overriding one or more of the plurality of automatic control actions has not been selected by the user of the application, transmitting, using the hardware processor, a first subset of the plurality of automatic control actions to one or more communication gateways that are each connected to at least one of the subset of connected devices and a second subset of the plurality of automatic control actions directly to a subset of the connected devices via a device cloud platform; and updating, using the hardware processor, the user interface to indicate that at least one of the first subset of the plurality of automatic control actions and the second subset of the plurality of automatic control actions have been performed on the portion of the connected devices and energy usage savings from the performance of the automatic control actions.

In accordance with some embodiments of the disclosed subject matter, a system for energy management is provided, the system comprising: means for determining connected devices from a plurality of devices that are eligible for automatic control, wherein the plurality of devices are connected to a communications network; means for determining available actions for each of the connected devices; means for generating a plurality of automatic control actions for at least a portion of the connected devices based at least in part on a dynamic rate of electricity generated by a dynamic rate engine and an energy mode selected by a user in an application, wherein the plurality of automatic control actions are based on the available actions for each connected device; means for causing a user interface to be presented in an application that indicates the plurality of automatic control actions for transmission to the portion of the connected devices, wherein the user interface provides a user interface element for overriding one or more of the plurality of automatic control actions; in response to determining that the user interface element for overriding one or more of the plurality of automatic control actions has not been selected by the user of the application, means for transmitting a first subset of the plurality of automatic control actions to one or more communication gateways that are each connected to at least one of the subset of connected devices and a second subset of the plurality of automatic control actions directly to a subset of the connected devices via a device cloud platform; and means for updating the user interface to indicate that at least one of the first subset of the plurality of automatic control actions and the second subset of the plurality of automatic control actions have been performed on the portion of the connected devices and energy usage savings from the performance of the automatic control actions.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an illustrative example of a schematic diagram for energy management using a load balancing application that includes a home scheduler system, a dynamic rate engine, an electronic billing system, and a solar and battery transaction system in accordance with some embodiments of the disclosed subject matter.

FIG. 2 shows an illustrative example of a home scheduler system in accordance with some embodiments of the disclosed subject matter.

FIG. 3 shows the data interactions between an asset register manager, a measurement data manager, and multiple device adapters in accordance with some embodiments of the disclosed subject matter.

FIG. 4 shows the multiple profiles that can be managed between an account manager, an asset register manager, and a service location manager in accordance with some embodiments of the disclosed subject matter.

FIG. 5 shows the data interactions between a scheduler optimizer that transmits automated control actions to a dispatcher, where the dispatcher communicates with a mobile application to provide the residential user with an opportunity to override or modify an automated control action prior to transmission to a suitable device or device adapter in accordance with some embodiments of the disclosed subject matter.

FIGS. 6A-11 show illustrative examples of user interfaces for interacting with the home scheduler system that includes energy consumption and cost reporting, budget alerts and automated control actions, profile settings and onboarding interfaces, and other suitable information in accordance with some embodiments of the disclosed subject matter.

FIGS. 12A and 12B show illustrative examples of residential tariffs that include a fixed commodity cost, a fixed T&D cost, and a variable T&D cost that is calculated based on the residential customer's monthly electrical energy usage in accordance with some embodiments of the disclosed subject matter.

FIG. 13 shows an illustrative example of a dynamic rate for the same daily residential customer load curve in accordance with some embodiments of the disclosed subject matter.

FIG. 14 shows an illustrative example of a dynamic rate engine in accordance with some embodiments of the disclosed subject matter.

FIG. 15 shows an illustrative example of user interfaces presented in connection with the dynamic rate engine in accordance with some embodiments of the disclosed subject matter.

FIG. 16 shows an illustrative example of an electronic billing and solar and battery transaction system components in accordance with some embodiments of the disclosed subject matter.

FIGS. 17-20 show illustrative examples of user interfaces presented in connection with the electronic billing system in accordance with some embodiments of the disclosed subject matter.

FIG. 21 shows an illustrative solar and battery transaction system in accordance with some embodiments of the disclosed subject matter.

FIG. 22 shows an illustrative battery optimization service in accordance with some embodiments of the disclosed subject matter.

FIG. 23 shows a schematic diagram of an illustrative system suitable for implementation of mechanisms described herein for energy management in accordance with some embodiments of the disclosed subject matter.

FIG. 24 shows a detailed example of hardware that can be used in a server and/or a user device of FIG. 23 in accordance with some embodiments of the disclosed subject matter.

FIG. 25 shows a range of vacancy confidence levels in accordance with some embodiments of the disclosed subject matter.

FIG. 26 shows an illustrative flow diagram for determining a vacancy confidence associated with a residential home, where the vacancy confidence can be determined based on live and historical occupancy data, in accordance with some embodiments of the disclosed subject matter.

### DETAILED DESCRIPTION

In accordance with various embodiments, mechanisms (which can include methods, systems, and media) for energy management are provided.

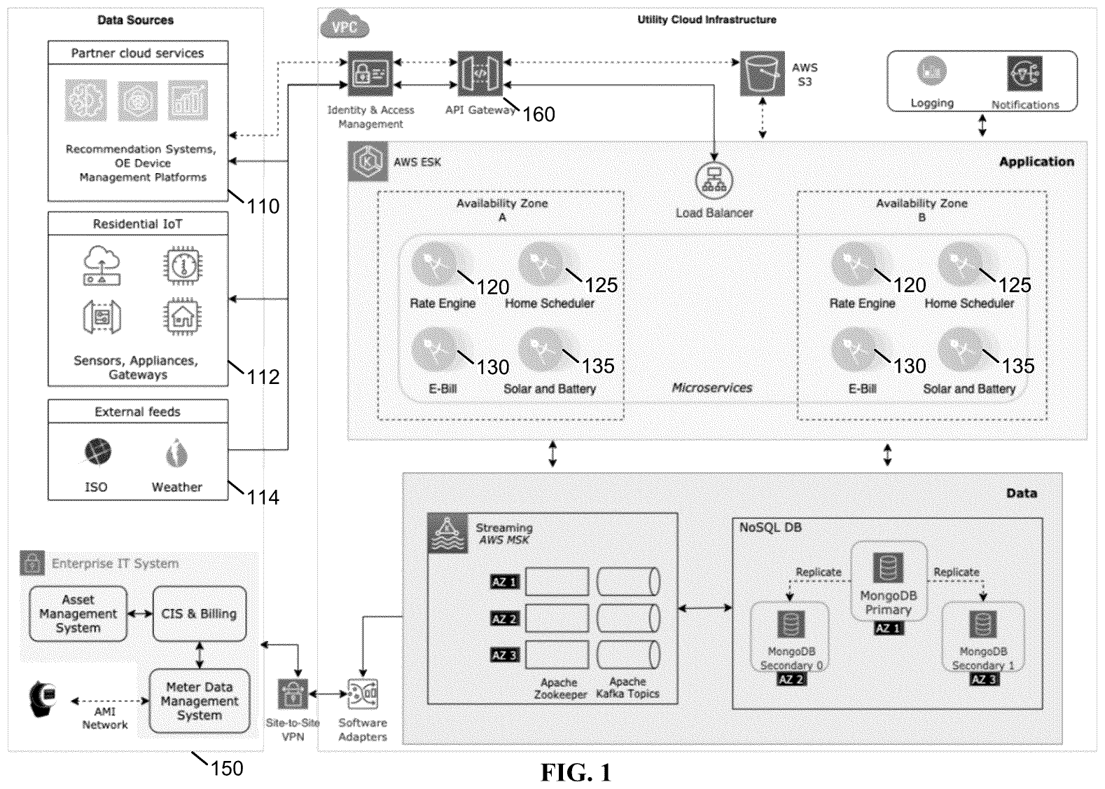

Generally speaking, the mechanisms described herein can provide utility providers with customized load flexibility while providing residential energy end users with a stable and predictable bill for their energy use. To do this, as shown in FIG. 1, the mechanisms include a dynamic rate engine 120 that generates an hourly price signal, a home scheduler 125 that provides coordinated automation of energy consuming systems and devices within a residential home, a billing interface 130 that provides residential utility customers with control over their energy use and real-time information, and a solar and battery transaction tool 140 for recommending an allocation of available solar and storage benefits according to each customer's needs and availability.

In some embodiments, a load balancing application can receive data from any suitable data source. For example, as shown in FIG. 1, the load balancing application can receive data from internal data sources, such as partner cloud services 110 (e.g., recommendation systems and device management platforms) and connected devices 112 within a residential home (e.g., sensors, smart appliances, smart thermostats, load controllers, and gateway devices). In another example, as also shown in FIG. 1, the load balancing application can receive data from external data sources, such as external data feeds 114 (e.g., weather data from a weather data service, energy data from independent service operators, etc.) and external system 150 associated with a utility provider (e.g., asset management systems relating to transformers, cables, and capacities, customer information systems, meter data management system, etc.).

It should be noted that, in some embodiments, data collected by the load balancing application can be aggregated and made available in any suitable manner. For example, in some embodiments, the data can be anonymized with respect to a residential home from which the data was collected and can be made available via any suitable Application Programming Interface (API) to the load balancing application.

In some embodiments, an API can be used to collect data related to energy use from one or more connected devices within a residence. For example, in some embodiments, an API gateway 160 can collect and/or aggregate data from multiple internal and external data sources (e.g., recommendation systems, connected devices, etc.) that relates to usage of thermostats within the residential building, usage of lights within the residential building, usage of window shades and window treatments within the residential building, usage of heating, cooling, and ventilating systems within the residential building, usage of hot water heaters within the residential building, usage of EV chargers within the building, usage of plug loads within the building, usage of pool pumps located at the residence, and/or usage of building equipment within building. As a more particular example, in some embodiments, API gateway 160 can collect and/or aggregate data such as thermostat settings at different times of day and/or days of the week, times lights within the building are turned on and/or turned off, temperatures within different portions of the building, an amount of outdoor sunlight around the building at different times of day, the weather at different times of day, occupancy levels of the building at different times of day, and/or any other suitable data.

It should be noted that, although the embodiments described herein generally describe the load balancing application being applied to a residential home, this is merely illustrative. The load balancing application can be used in connection with any suitable type of building, such as an office building, a house, an apartment building, a school, and/or any other suitable building. In some embodiments, energy usage within the building can be controlled by any suitable devices, such as smart thermostats, smart lights, smart window shades and window treatments, smart appliances, gateway devices that communicate with connected devices within the building, device adapters that communicate with connected devices within the building, etc. In some embodiments, thermostats can be any suitable smart thermostats (e.g., that automatically adjust temperature settings and/or any other suitable settings) that can be controlled by the load balancing application and non-connected thermostats in which the user is provided with a recommendation to adjust temperature settings and/or any other suitable settings.

### Home Scheduler System

Generally speaking, the home scheduler can generate actions and recommendations for energy cost savings against the dynamic rate at a device level at every hour or any other suitable interval. Such actions can include automated control commands that are sent to controllable devices (e.g., systems and devices that are within a residential home). Additionally or alternatively, such recommendations can be generated for major uncontrolled devices typical to homes to prompt a residential user to intervene manually (e.g., prompt the residential user to change a setting on a device that cannot be automatically controlled). Both the actions and recommendations can, for example, be designed to avoid energy consumption during high hourly electricity prices so that the user stays within their target budget, without overburdening the user or sacrificing comfort.

In some embodiments, the home scheduler can determine whether a device is eligible for automatic control in a predetermined time. For example, the home scheduler can determine whether a device is eligible for automatic control for the upcoming hour and, in response to determining that the device is an eligible device, the home scheduler can identify the actions for automatic control for the upcoming hour. In continuing this example, the home scheduler can perform a determination as to which devices are eligible for automatic control at a particular frequency (e.g., at the start of each hour).

In some embodiments, to determine whether a device is eligible for automatic control, the home scheduler can determine mobile application status information and device status information. For example, the home scheduler can determine that a device is eligible for automatic control in response to determining that a residential user has set an autopilot mode in a mobile application associated with the home scheduler in which the autopilot status allows the home scheduler to automatically control systems and/or devices within a home of the residential user. In a more particular example, the home scheduler can transmit automatic device control actions to suitable systems and/or devices within the home of the residential user in response to determining that the autopilot mode has been set in the mobile application associated with the home scheduler and that the devices to be controlled are connected (e.g., to a home network) and turned on. In another more particular example, the home scheduler can transmit recommendations to the mobile application that prompts the residential user to make manual adjustments that generate energy cost savings in response to determining that the autopilot mode has been turned off in the mobile application. In yet another more particular example, in response to determining that mobile application status information indicates that the autopilot mode is turned off, the home schedule can transmit recommended control actions that prompt the residential user to allow the mobile application to transmit instructions to adjust settings on one or more systems and/or devices within the home of the residential user.

It should be noted that device status information can include device information and status data for smart meter devices, load monitoring devices, and/or in-home smart devices, where the device information and the status data can be stored in an asset register manager. For example, a connected smart controller can be connected to a user device in which the connected smart controller obtains device information and status data from the user device. In a more particular example, a smart plug device can be connected entertainment units, television devices, lighting devices, etc. and obtain device status information (e.g., on or off) and instantaneous energy data (e.g., kW and kWh data). In another more particular example, a smart thermostat device can be connected to a central heating and cooling system and obtaining device status information (e.g., off, auto, heat, or cool), temperature information (e.g., indoor temperature), temperature units (e.g., Celsius or Fahrenheit), etc.

It should also be noted that, by transmitting instructions to a smart controller device, the home scheduler can transmit one or more control actions to a user device connected to the smart controller device. For example, the home scheduler can transmit a control action to a smart plug device that turns an electronic device that is connected to the smart plug device to an on state or an off state. In another example, the home scheduler can transmit a control action to a smart thermostat device that controls system mode, heating setpoint, or cooling setpoint on a connected heating and cooling system.

It should further be noted that, in some embodiments, any suitable level of control of a user device can be available using a smart controller device. For example, a residential user can provide settings that indicate a level of control for a connected user device (e.g., on/off state, but not cooling set point). In another example, a connected user device can allow a subset of control actions to be controlled by the home scheduler.

In some embodiments, to determine whether a device is eligible for automatic control, the home scheduler can determine the current price of electricity generated by the dynamic rate engine. For example, the home scheduler can determine that a device or system within a home of the residential user is eligible for automatic control and can trigger automatic interventions to reduce energy consumption in response to determining that a set price threshold in comparison with the current price of electricity has been reached. In a more particular example, the home scheduler can generate a control schedule based on the forecasted price of electricity that minimizes the cost to operate that device within the bounds of the user's stated or learned preferences.

In some embodiments, to determine whether a device is eligible for automatic control, the home scheduler can determine a target energy cost budget (sometimes referred to herein as an “energy mode”) that was selected by the residential user in connection with the billing interface. For example, using the billing interface, the residential user can be prompted to select one of three tiered target budgets: comfort, balanced, and saver (which can, in this example, progress from highest target budget to lowest target budget). In continuing this example, each energy mode can correspond to progressively higher price sensitivity and, therefore, more frequent control by the home scheduler. In a more particular example, a residential user that has selected the saver energy mode can experience interventions at a lower price threshold and, therefore, experience additional interventions in the systems and/or devices within the home of the residential user than a residential user that has selected the comfort energy mode. In yet another more particular example, the residential user that has selected the saver energy mode can experience a larger shift in their standard appliance usage, such as a higher temperature setting during peak cost hours in the cooling season or a longer window of time to charge their electric vehicle.

In some embodiments, to determine whether a device is eligible for automatic control, the home scheduler can determine the current availability of community solar and battery shares. For example, if the residential user has purchased shares of assets that produce electricity and if the assets are currently producing electricity (e.g., any amount of solar and battery dispatch is taking place), the home schedule can determine that no interventions are needed and that no automatic device control will take place for that hour.

In some embodiments, to determine whether a device is eligible for automatic control, the home scheduler can compare the residential user's actual and forecasted monthly cost with a budget set by the residential user in connection with the billing interface. For example, based on energy consumption data collected from a smart meter device, the home scheduler can compare the actual and/or forecasted monthly energy cost from the smart meter device that collects energy usage data from connected in-home devices with a budget set by the residential user in the billing interface.

In some embodiments, to determine whether a device is eligible for automatic control, the home scheduler can analyze the source and frequency of device control actions during a particular time period (e.g., a day, a week, etc.). For example, based on an analysis of the source and frequency of device control actions during a particular time period, the home scheduler may not control device during lockout windows, which can be triggered for a set period of time after a residential user overrides a control action or makes a manual device adjustment that conflicts with the automated action. In continuing this example, a lockout can occur after a set number of actions have taken place for that device in a single day, which can prevent the user from feeling overruled or inconvenienced by the home scheduler.

In response to the home scheduler determining whether a device is eligible for automatic control and determining whether control actions are appropriate, the home scheduler can trigger automatic control actions for the devices based on the preferences that have been set by the residential user. Example control actions can include switching off a device, adjusting the temperature setpoint to lower HVAC energy consumption during that hour, and pre-heating or cooling in anticipation of high electricity prices.

It should be noted that the residential user can configure preferences in any suitable manner. For example, a mobile application can be executed on a mobile device associated with the residential user in which the mobile application allows the residential user to configure preferences, such as selecting an energy mode that can impact the frequency of interventions, turning off an autopilot mode which can stop automatic interventions, setting indoor temperature setpoint preferences which can inform the heating and cooling interventions, etc.

It should also be noted that, in some embodiments, the home scheduler can transmit notifications about upcoming control actions to the mobile application. For example, in response to receiving a notification about an upcoming control action (e.g., to turn off an HVAC unit), the residential user can use the mobile application to override the control action. Additionally or alternatively to transmitting notifications, the home scheduler can also transmit energy management recommendations to the residential user that prompts the residential user to manually manage uncontrolled loads within the home, such as running high energy consuming loads (identified in the recommendation) during periods of low forecasted electricity prices.

In some embodiments, the home scheduler can be configured to determine whether one or more devices are eligible for automatic control and determining whether control actions or recommendations are appropriate at any suitable frequency. For example, the determination as to whether one or more devices are eligible for automatic control and the determination as to whether control actions are appropriate can be performed at each hour. As such, the cost and energy impact of automated actions executed by the home scheduler can be tracked at the device level and the home level by the billing interface. In turn, the billing interface can allow a residential user to determine the effectiveness of automatic control in real time and over time.

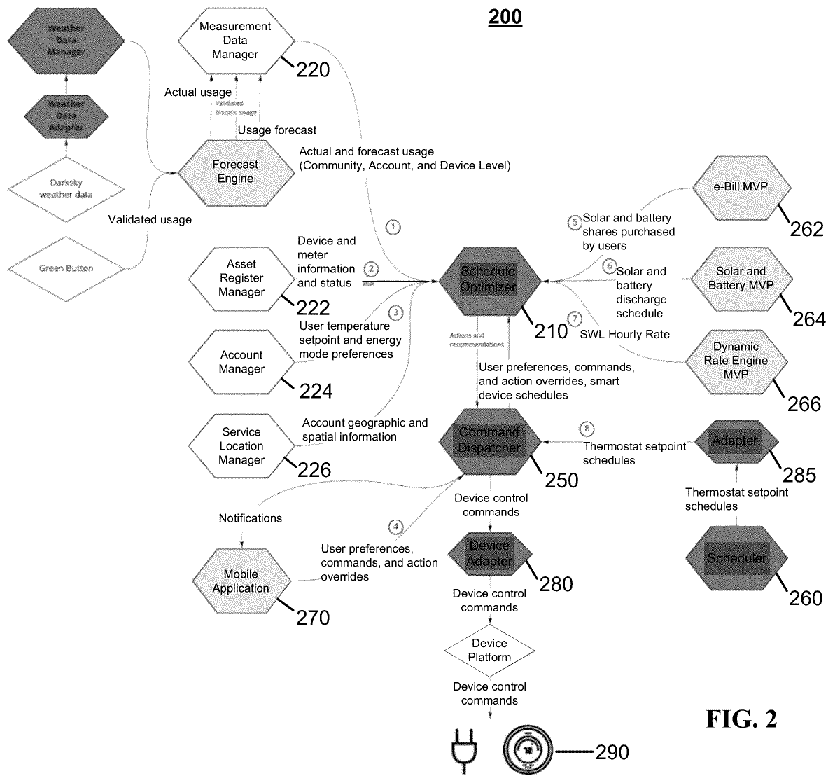

Turning to FIG. 2, an illustrative flow diagram of a home scheduler system 200 is shown in accordance with some embodiments of the disclosed subject matter. As shown, the home scheduler system can receive inputs from utility databases 220-226, a dynamic rate engine system 280, a solar and battery system 282, an electronic billing system 284, and from a residential user through one or more user interfaces being presented on an application 270 being executed by a computing device (e.g., a mobile device associated with the residential user). These inputs can be transmitted to a scheduler optimizer 210, where device control actions and/or recommendations can be generated. In turn, device control actions and/or recommendations generated by scheduler optimizer 210 can be transmitted to a command dispatcher 250 that determines where to transmit the received device control actions and/or recommendations. For example, recommendations for manual intervention can be transmitted from command dispatcher 250 to application 270 in the form of a notification or any other suitable user interface element. In another example, device control action can be transmitted to a communication gateway 280 that communicates (e.g., wirelessly) with one or more connected devices 290, where the transmitted action can cause an action to be automatically performed on connected device 290 (e.g., increase cooling temperature, decrease fan, etc.). In yet another example, command dispatcher can determine that the device control action corresponds with a device 295 that is connected to a device adapter 285 and, in turn, can transmit the device control action to device adapter 285, where the transmitted action can cause an action to be automatically performed on connected device 295 (e.g., increase cooling temperature, decrease fan, etc.).

It should be noted that the home scheduler system can receive any suitable inputs, such as one or more inputs from utility data management software. For example, scheduler optimizer 210 of the home scheduler system 200 can receive inputs from one or more utility databases associated with the utility data management software. As shown in FIG. 2, the utility databases can include a measurement data manager 220, an asset register manager 222, an account manager 224, and a service location manager 226. For example, measurement data manager 220 can be a database that is located in the measurement data management system of a utility provider, asset register manager 222 can be a database that is located in the asset management system, account manager 224 can be a database that is located in the customer information system of a utility provider, and service location manager 226 can be a database that is located in a geographic information system of a utility provider.

In a more particular example, as shown in FIG. 2, measurement data manager 220 can retrieve actual and forecasted energy usage from a measurement data management system associated with a utility provider. For example, scheduler optimizer 210 of the home scheduler system can retrieve the actual energy usage data (e.g., a total usage for the current month) and the forecasted energy usage data (e.g., a projected usage for the remainder of the month) at the community level, the account level, and/or the device level from measurement data management system 220 that collects such data from (1) load monitoring devices, which can capture device level energy consumption data in hourly increments and can transmit this data to a communication gateway between the in-home devices and the home scheduler in real time, (2) smart meter devices, which can capture home energy consumption data and can transmit this data to the communication gateway in real time, (3) an advanced metering infrastructure, which can capture home energy consumption data in hourly increments to the home scheduler, and/or (4) a usage forecast engine, which can transmit forecasted energy consumption in hourly increments (e.g., where a minimum, average, and maximum consumption estimate can be generated at the beginning of each month for every hour of the month and can be re-forecasted at the beginning of each day for the next twenty-four hour period). In another example, a communication gateway can collect data wirelessly from connected devices and the smart meter device and can package and transmit the collected data to the cloud-based home scheduler system.

It should be noted that, in some embodiments, the same type of data can be received from multiple sources, such as energy consumption data from a load monitoring device that serves as a communication gateway between connected devices in a residence and the home scheduler system and energy consumption data from an advance meter infrastructure. In such embodiments, the home scheduler system can determine which data source provides more accurate data and uses the data, such as the energy consumption data, from that data source. A determination of accuracy can be based, for example, on a comparison of forecasted energy consumption data with actual energy consumption data over a particular time period.

In response to receiving this input data from measurement data manager 220, scheduler optimizer 210 of the home scheduler system can use this input data to determine whether or not the residential user is on budget (e.g., a monthly energy budget) and to determine whether connected devices are eligible for automatic control actions. For example, as shown in FIG. 2, scheduler optimizer 210 of the home scheduler system can transmit an automatic control action for one or more controllable devices to a command dispatcher 250, which, in turn, can transmit the automatic control action or any other suitable device control commands to communication gateway 280 and/or device adapter 285 that each communicate with one or more controllable devices 290 and 295.

In another more particular example, as shown in FIG. 2, asset register manager 222 can retrieve device and meter information and status information from an asset management system associated with a utility provider. For example, scheduler optimizer 210 of the home scheduler system can retrieve device and meter information and status information from asset register manager 222 that contains device information and status data for smart meter devices, load monitoring devices, and/or in-home smart devices. Device status data (such as on/off, temperature setpoint, etc.) can be transmitted to the home scheduler system through a communication gateway or device communication hub. An illustrative example of the status data that can be collected for each device and the frequency of that data collection is shown below in Table 1.

TABLE 1

| | Illustrative | | |
|---|---|---|---|
| | Examples of | | Collection |
| User Device | Connected Smart | | Frequency |
| Examples | Controllers | Data Available | (in minutes) |
| Device | Rainforest | | |
| Communication Hub | Automation Eagle- | | |
| | 200 Gateway | | |
| Baseboard Heating | Sinope | Device Status: On/Off | 15 minutes |
| | Baseboard Line | | |
| | Voltage Thermostat | | |
| Wall Loads | Salus | Device Status: On/Off | 15 minutes |
| (Entertainment Units, | Smart Plug | Instantaneous kW and kWh data | |
| TVs, Lights, etc.) | | | |
| Washer, Dryer, | Sinope | Device Status: On/Off | |
| Dishwasher, | Load Controller | Instantaneous kW and kWh data | |
| Stove/Range, fridge | | | |
| Central Heating and | Salus | Device Status: | 15 minutes |
| Cooling System | Smart Thermostat | Off/Auto/Heat/Cool | |
| | Sinope Load | Indoor Temperature | |
| | Controller | Temperature units: C. or F. | |
| Domestic Hot Water | Sinope Load | Energy consumption | 15 minutes |
| Heater (Electric) | Controller | | |
| Portable Air | ThinkEco | Device Status: On/Off | 15 minutes |
| Conditioning Unit | SmartAC Kit | Thermostat Mode: Cooling/Fan | |
| | | Only | |
| | | Current Cooling SetPoint | |
| | | Current Cooling Offset | |
| | | Indoor Temperature | |
| | | Temperature units: C. or F. | |
| | | Duty Cycle | |
| | | Fan Speed | |
| Refrigerator, washing | LG ThinkQ | Device Status: On/Off | |
| machine, electric | | Instantaneous kW and kWh data | |
| dryer, portable AC, | | | |
| induction stove, | | | |
| convection oven | | | |

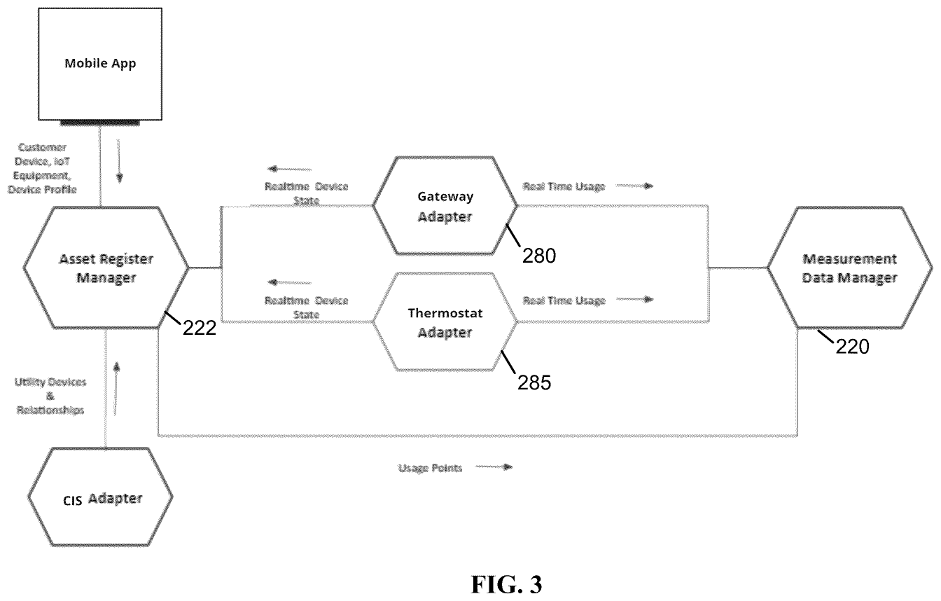

It should be noted that different types of information can be retrieved by the different utility databases in FIG. 2. For example, as shown in FIG. 3, asset register manager 222 can retrieve real-time device state information from multiple devices, such as device adapter 285 for heating and/or cooling devices, communication gateway 280 for other connected devices, and/or any other suitable device adapter, while measurement data manager 220 can retrieve real-time usage information from those multiple adapter devices. As such, asset register manager 222 can manage the asset-related metadata (e.g., asset type, model, vendor information, etc.), capture state information and change of state information for an asset, and manage relationships of an asset (e.g., asset to home network, asset to owner, asset to utility network, etc.), and measurement data manager 220 can aggregate consumption data, such as metered usage data, appliance level consumption data, and solar generation data, thereby streaming real-time consumption data and device state for customer devices and IoT equipment to scheduler optimizer 210 of the home scheduler system. In continuing this example, a mobile application can subscribe to this real-time consumption data and device state information to allow a residential user to make informed decisions about energy usage apart from monitoring device usage and cost.

In another more particular example, referring back to FIG. 2, account manager 224 can retrieve user temperature setpoint information, energy mode preferences, and other user account and home profile information from a customer information system associated with a utility provider and service location manager 226 can retrieve geographic and spatial information associated with a user account from a geographic information system associated with the utility provider. For example, account manager 224 can provide a user's temperature setpoint preferences, which can be used to inform automatic setpoint adjustments, as well as the user's selected energy mode. In another example, service location manager 226 can retrieve information about the home layout and device locations, including spatial elements of the building, and building systems locations (such as HVAC, lights, electrical, water subsystems).

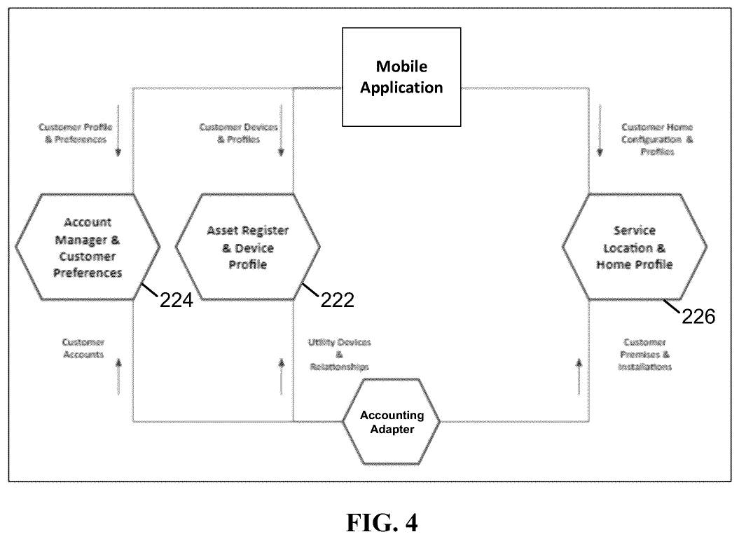

It should be noted that, in some embodiments, customer, home, and device profiles can be maintained and managed by the home scheduler system. For example, as shown in FIG. 4, account manager 224 can manage customer account related information, such as demographic information about individuals and businesses, account information, contract or service agreement details, customer profile and preference information, etc., while asset register manager 22 can additionally include device profile information for the assets of the residential user. Additionally, as shown in FIG. 4, service location manager 226 can manage service location-related information, such as geographic information about service locations, relationship information between a service location and usage points, home details (e.g., year built, size, property purpose, property type, property style, exterior type, etc.), home configuration information (e.g., number of rooms, number of bathrooms, thermostat locations, device locations, etc.), etc.

In yet another more particular example, as shown in FIG. 2, scheduler optimizer 210 can receive inputs from a suitable third party energy management source or third party device adapter, such as a scheduler 260. In continuing this example, optimized temperature setpoints can be provided by scheduler 260 for connected heating and cooling devices. Scheduler 260 can identify hourly temperature setpoints that can save heating and cooling costs for each device and can transmit these temperature setpoints to scheduler optimizer 210 of the home scheduler system.

In a further particular example, scheduler optimizer 210 can receive inputs from other corresponding systems to the home scheduler system.

As shown in FIG. 2, scheduler optimizer 210 of the home scheduler system can receive solar and battery share information from electronic billing system 262 and solar and battery system 264. For example, scheduler optimizer 210 of the home scheduler system can receive subscription information indicating the number of solar and/or battery shares that have been purchased for the latest billing cycle from electronic billing system 262 and generation and dispatch schedule information for solar and battery shares from solar and battery system 264.

As also shown in FIG. 2, scheduler optimizer 210 of the home scheduler system can receive current and forecasted hourly electricity prices generated by dynamic rate engine system 266. In continuing this example, scheduler optimizer 210 of the home scheduler system can use the current and forecasted hourly electricity prices generated by dynamic rate engine system 266 to calculate the average price for the upcoming control outlook window. It should be noted that the control outlook window can be a configurable period of time set by any suitable entity (e.g., a six hour period set by a utility provider). In response to determining that the weighted average price of electricity is higher than the price threshold, scheduler optimizer 210 can determine whether an action should be taken or whether a recommendation should be made.

In some embodiments, in response to scheduler optimizer 210 of the home scheduler system determining that an automatic control action should be taken for one or more controllable devices, command dispatcher 250 can transmit user initiated control commands and action overrides in the form of a notification or a user interface element to application 270 being executed by a computing device (e.g., a mobile device associated with the residential user). For example, a notification can be presented on application 270 being executed by the computing device that prompts the user to override an automatic control action that will be transmitted to a connected device within the residential home of the user. In continuing this example, in response to not overriding the automatic control action via the notification being presented on application 270 being executed by the computing device, command dispatcher 350 can proceed to transmit the automatic control action to a connected device (e.g., via communication gateway 280 and/or device adapter 285).

It should be noted that scheduler optimizer 210 of the home scheduler system can have any suitable control sequence. For example, at each hour, scheduler optimizer 210 can determine whether or not each device meets the eligibility criteria described above for control and generates control actions and/or recommendations for each eligible device. As such, actions and/or recommendations can then be sent to command dispatcher 250 to be communicated to the user via application 270 and to the devices 290 and 295 via communication gateway 280 and/or device adapter 285.

It should also be noted that eligibility checks can be performed for each device prior to scheduler optimizer 210 triggering an action. For example, an eligibility check can be a series of if/then statements that determine which device loads should be shifted or curtailed during periods of relatively high electricity prices. In a more particular example, the criteria can be checked in the following hierarchical order:
1. Determining whether a price threshold has been met (e.g., a price threshold can be set manually each month by a utility system administrator for each energy mode and device type based on an estimate of the average peak price for the month and scheduler optimizer 210 can determine whether a weighted average price for electricity is higher than the price threshold for the user's selected energy mode);
2. Determining whether an autopilot status is set to an “on” or active mode (e.g., scheduler optimizer 210 can determine whether the user has activated an autopilot mode in application 270 executing on a computing device, which can permit automatic device control of one or more connected devices);
3. Determining whether a connected device is currently turned on and is communicating with a suitable communication gateway or device adapter;
4. Determining whether solar and/or storage shares are available based on forecast output and user share subscription (e.g., scheduler optimizer 210 can determine whether the user has solar and battery shares that are producing energy during that hour);
5. Determining whether the projected monthly cost is greater than the budgeted cost (e.g., scheduler optimizer 210 can determine whether the user is not on track to meet their target budget based on their cost to date and forecasted energy cost for the month);
6. Determining whether the current hour is not within the scheduler lock window (e.g., scheduler optimizer 210 can determine whether the device has not been controlled by the home scheduler system in the last five hours or any other suitable time period);
7. Determining whether the current hour is not in an active user rejection lock window (e.g., scheduler optimizer 210 can determine whether the user has not rejected a home scheduler action for the device within the last six hours or any other suitable time period);
8. Determining whether the current hour is not in an active user action lock window (e.g., scheduler optimizer 210 can determine whether the user has not adjusted the device through application 270 in the last three hours or any other suitable time period); and
9. Determining whether a max interruption threshold for the device has not been reached for the day (e.g., scheduler optimizer 210 can determine whether a device has not been automatically controlled by the home scheduler system more than four times that day or any other suitable limit).
   In another more particular example, the criteria can be checked in the following hierarchical order:
1. Determining whether an autopilot status is set to an “on” or the home scheduler system is otherwise turned on (e.g., scheduler optimizer 210 can determine whether the user has activated an autopilot mode in application 270 executing on a computing device, which can permit automatic device control of one or more connected devices);
2. Determining whether a device has been intervened with in a particular period of time (e.g., the last sixty minutes) in comparison with a minimum intervention interval;
3. Determining a number of device interventions with the particular device in a particular period of time (e.g., a day) in comparison with a maximum number of device interventions (e.g., no device interventions if the maximum number of device interventions has been reached);
4. Determining season information and ambient temperature information for heating controls (e.g., heating using an HVAC device can be controlled if it is between the months of November and April and ambient temperature is above a particular threshold temperature);
5. Determining season information and ambient temperature information for cooling controls (e.g., cooling using an HVAC device can be controlled if it is between the months of May and October and ambient temperature is below a particular threshold temperature); and
6. Determining whether an automated control action has been overridden by the residential user (e.g., in response to selecting a user interface element on a mobile application that notifies the user of the automated control action).
   In continuing these examples, in response to determining that each of the above-mentioned criteria is met for a device, scheduler optimizer 210 of the home scheduler system can deem the device as being eligible for automatic control and scheduler optimizer 210 can trigger one or more control actions for the device. Automatic control actions generated by scheduler optimizer 210 can include, for example, a device shut off for wall plug loads, a temperature setpoint adjustment for heating and cooling equipment, etc. An illustrative example of control capabilities for each device type is shown below in Table 2.

TABLE 2

| | Illustrative | |
|---|---|---|
| | Examples of | |
| | Connected Smart | |
| User Device Examples | Controllers | Control Actions |
| Device Communication Hub | Rainforest | N/A |
| | Automation Eagle- | |
| | 200 Gateway | |
| Baseboard Heating | Sinope | Set System Mode: On/Off |
| | Baseboard Line | Set Heating Setpoint |
| | VoltageThermostat | |
| Wall Loads (Entertainment | Salus | Set System Mode: On/Off |
| Units, TVs, Lights, etc.) | Smart Plug | |
| Washing machine, Dryer, | Sinope | Set System Mode: On/Off |
| Dishwasher, Stove/Range, | Load Controller | |
| Refrigerator | | |
| Central Heating and Cooling | Salus | Set System Mode: |
| System | Smart Thermostat | Off/Auto/Heat/Cool/Emergency Heat |
| | | Set Thermostat Mode COOL/HEAT |
| | | Set Heating Setpoint |
| | | Set Cooling Setpoint |
| | | Set Fan Speed ON/AUTO |
| Portable Air Conditioning | ThinkEco | Set System Mode: ON/OFF |
| Unit | SmartAC Kit | Set Thermostat Mode |
| | | Apply Cooling Offset |
| | | Set Cooling Setpoint |
| | | Set Duty Cycle |
| | | Set Fan Speed |
| Refrigerator, washing | LG ThinkQ | No Control Capability |
| machine, electric dryer, | | |
| portable AC, induction stove, | | |
| convection oven | | |

For example, in response to determining that a device is eligible for automated control and in response to determining that the weighted average price is greater than the price threshold corresponding to the user's selected energy mode, scheduler optimizer 210 of the home scheduler system can transmit an automated control action that causes the device to be powered off In continuing this example, the device can be powered on at the end of the control hour or at any suitable time (e.g., after the expiration of a time window). Such automated control actions can be transmitted by scheduler optimizer 210 to controllable devices based on a set of predetermined rules and conditions—e.g., controls to switch off a device, controls to preheat or precool, controls to delay the start of an appliance, controls to change the setpoint of an appliance, etc.

In another example, in connection with device scheduler 260, device scheduler 260 can use machine learning to predict hourly electricity costs for heating and cool and, in turn, can propose optimized hourly temperature setpoints for each residential home that minimize costs within the bounds of the user's minimum and maximum setpoint preferences. Such a machine learning algorithm can rely on historical and forecasted hourly weather, hourly electricity price forecast, whole home electricity consumption data, on/off run-time and electricity consumption from heating and cooling appliances, and corresponding temperature setpoints from those appliances. It should also be noted that the machine learning algorithm can also take into account user preferences for maximum and minimum indoor temperature setpoints.

The machine learning algorithm can use this data to predict hourly energy consumption and cost for heating and cooling for a particular time period (e.g., a twenty-four period) and to generate an optimized temperature setpoint schedule based on a targeted heating or cooling cost or energy savings for that period. Device scheduler 260 can transmit optimized temperature setpoint schedules for heating and/or cooling equipment to scheduler optimizer 210, where the device control eligibility rules can be applied to determine whether or not to dispatch the setpoints to the heating and/or cooling device. It should be noted that the user's current setpoint or setpoint schedule can be maintained for all hours that the device scheduler's temperature setpoints are not dispatched.

Turning back to FIG. 2, in response to scheduler optimizer 210 of the home scheduler system determining that an automatic control action should be taken for one or more controllable devices, scheduler optimizer 210 can transmit automatic control actions and/or recommendations to command dispatcher 250, which can route control actions to the appropriate device control services—for example, device adapter 285 for heating and/or cooling devices and communication gateway 280 for other connected devices.

It should be noted that scheduler optimizer 210 of the home scheduler system can have any suitable control sequence. For example, at each hour, scheduler optimizer 210 can determine whether or not each device meets the eligibility criteria described above for control and generates control actions and/or recommendations for each eligible device. In another example, at each hour, scheduler optimizer 210 can select a particular subset of devices (e.g., previously eligible devices, previously active devices, devices that have received a number of automatic control actions greater than a threshold value, etc.) to determine whether or not each device in the subset of devices meets the eligibility criteria for control and generates control actions and/or recommendations for each eligible device. As such, actions and/or recommendations can then be sent to command dispatcher 250 to be communicated to the user via application 270 and to the devices 290 and 295 via communication gateway 280 and/or device adapter 285. The communication gateway 280 and/or device adapter 285 can transmit those actions over their platforms and on to the devices that they respectively manage.

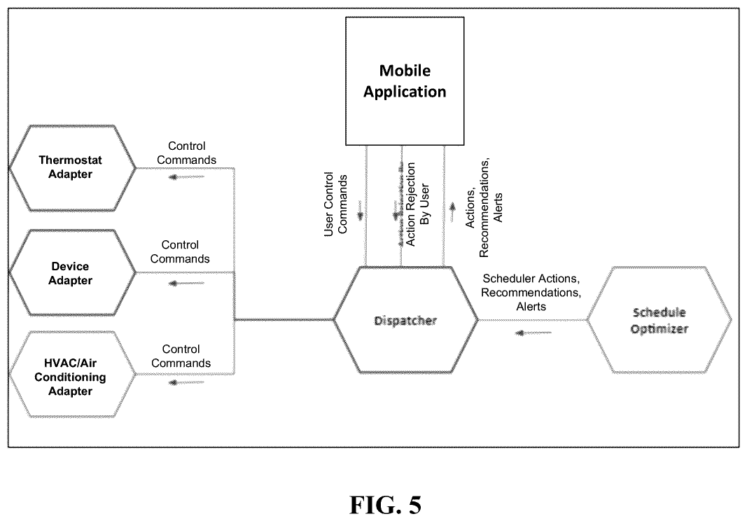

It should also be noted that, in some embodiments, prior to communication gateway 280 and/or device adapter 285 transmitting automatic control actions to the respective device, command dispatcher 250 can transmit a notification to application 270 executing on a computing device. For example, the notification can provide the residential user with the opportunity to override or otherwise inhibit the automated control action from being executed. If the user overrides the automated control action or if the automated control action conflicts with another control command that the user has initiated through the device or the application (e.g., changing the temperature setpoint on a thermostat device), no device control can take place in that hour. The device can remain ineligible for control for the period defined by the user rejection or user action lockout window. Alternatively, if the user does not override the automated control action prior to the control window, the automated control action can be transmitted from communication gateway 280 and/or device adapter 285 to the appropriate device. This flow of scheduler actions, recommendations, and/or alerts from the scheduler optimizer to the command dispatcher, which communicates with a mobile application and multiple devices adapters to determine whether a control command should be transmitted, is also shown in FIG. 5.

It should further be noted that, in some embodiments, prior to communication gateway 280 and/or device adapter 285 transmitting automatic control actions to the respective device, command dispatcher 250 can determine that multiple control actions are directed to a particular device or asset. In response, command dispatcher 250 can package the control actions by each asset and transmit the package of control actions to the asset. Similarly, the device adapter or communication gateway that receives the package of control actions can transmit a response that provides a status update on the execution of each of the control actions in the received package.

Additionally, in some embodiments, in response to determining that a device is not eligible for receiving an automated control action from command dispatcher 250 of the home scheduler system, a recommendation can be transmitted to application 270 executing on a computing device. For example, in response to receiving device level consumption data from a communication gateway that is communicating with a load controller to a dishwasher device, in response to determining that the weighted average energy price is greater than the price threshold corresponding to the user's selected energy mode, and in response to determining that the dishwasher device is not eligible for control with an automated control action, a recommendation to modify the operation of the dishwasher device can be transmitted to application 270 executing on a computing device to prompt the residential user to intervene manually (e.g., prompt the residential user to change a setting on a device that cannot be automatically controlled). In a more particular example, a recommendation can prompt the user to switch off a device, to run a device at a particular hour in the day (e.g., the best time this evening to run the washing machine is between 9:00 PM and 11:00 PM), or to perform a particular action within the home (e.g., keep your blinds open/close today if temperature for a predefined window is above a particular temperature or below a particular temperature).

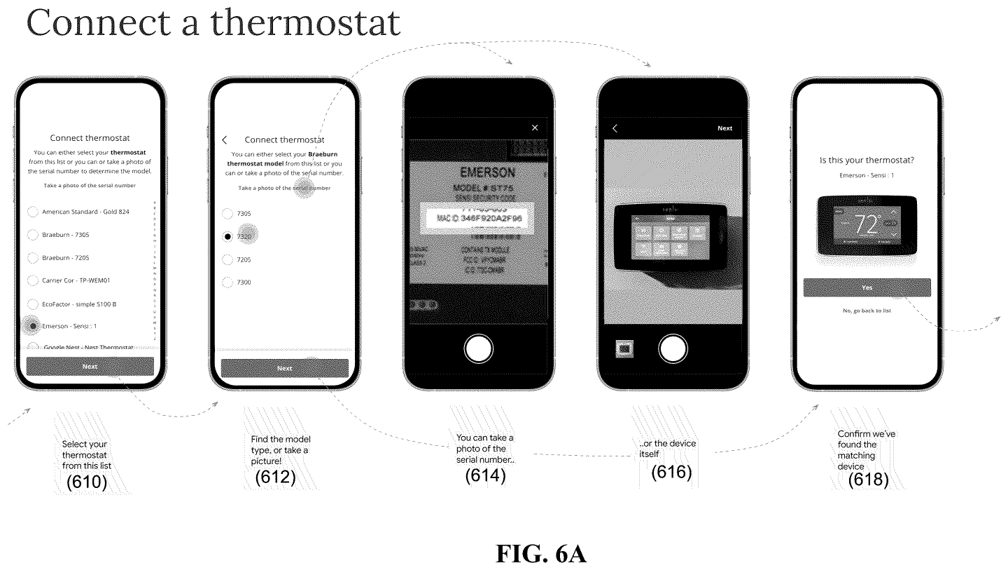

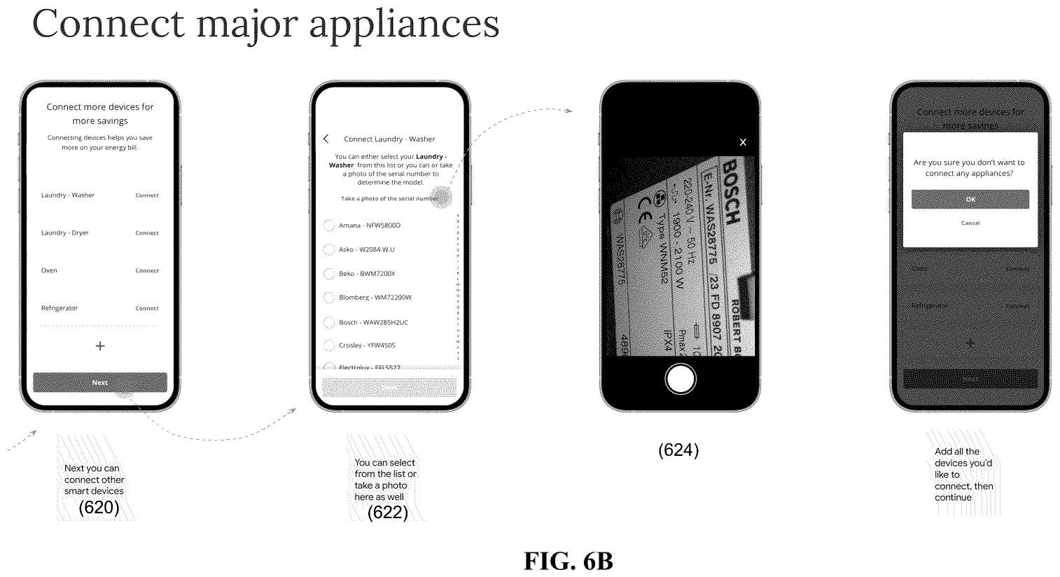

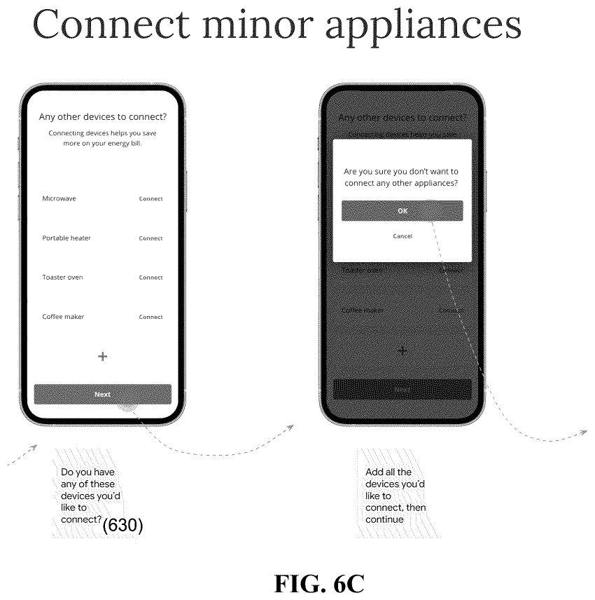

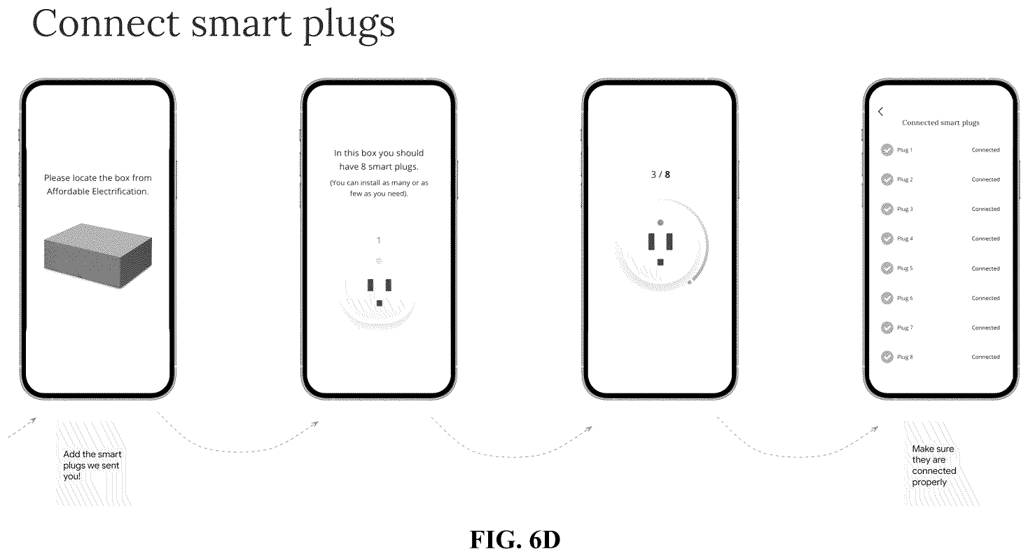

Illustrative examples of the user interfaces that can be presented on application 270 are shown in FIGS. 6A-8.

For example, FIG. 6A provides illustrative examples of user interfaces for connecting a thermostat device, which can include selecting a particular thermostat device from a list of thermostat devices at 610 and 612, capturing an image of a serial number, model number, or other device identifier at 614 using an imaging device associated with a mobile device on which application 270 is executing, capturing an image of the thermostat device itself at 616, and/or confirming that a matching device has been found by application 270 at 618.

In another example, FIG. 6B provides illustrative examples of user interfaces for connecting a major appliance, which can include connecting a smart appliance by selecting a particular smart appliance (e.g., a smart washer, a smart dryer, a smart oven, a smart refrigerator, etc.) from a list of smart appliances at 620 and 622, capturing an image of a serial number, model number, or other device identifier or capturing an image of the smart appliance itself at 624 using an imaging device associated with a mobile device on which application 270 is executing, and/or confirming that a matching major appliance has been found by application 270.

In a further example, FIG. 6D provides illustrative examples of user interfaces for connecting one or more smart plugs that were provided in a kit associated with the home scheduler system.

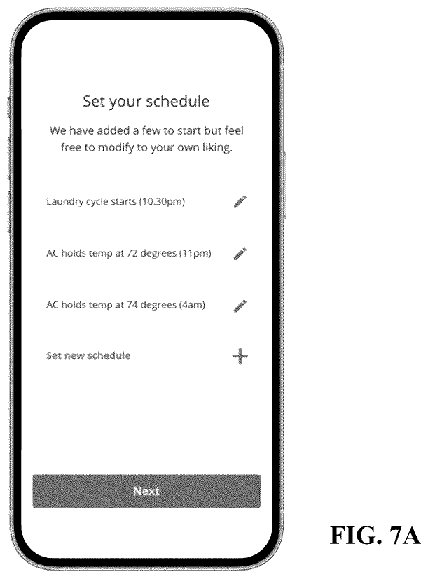

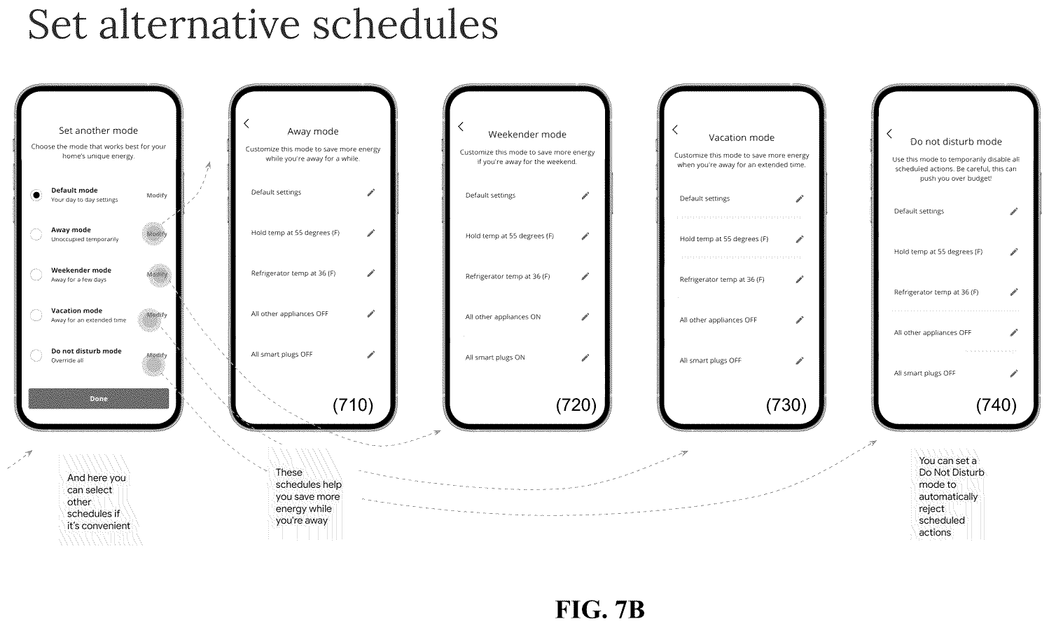

In some embodiments, user interfaces can be provided for creating one or more schedules for the connected devices. For example, FIG. 7A provides an illustrative example of a user interface for setting a regular schedule associated with the home scheduler system. As shown, this can include turning on a smart appliance (e.g., a smart washer) at a particular time, holding particular temperatures at particular times, etc. In another example, FIG. 7B provides illustrative examples of user interfaces for setting alternative schedules that are each associated with a selected energy mode—e.g., away mode at 710 for connected device settings when the residents of the residential home have been away for a particular period of time, weekender mode at 720 for connected device settings when the residents of the residential home are away for a weekend, vacation mode at 730 for connected device settings when the residents of the residential home are away for an extended period of time, and/or a do not disturb mode at 740 that temporarily disables scheduled actions for connected devices such that scheduled actions for connected devices can be automatically rejected.

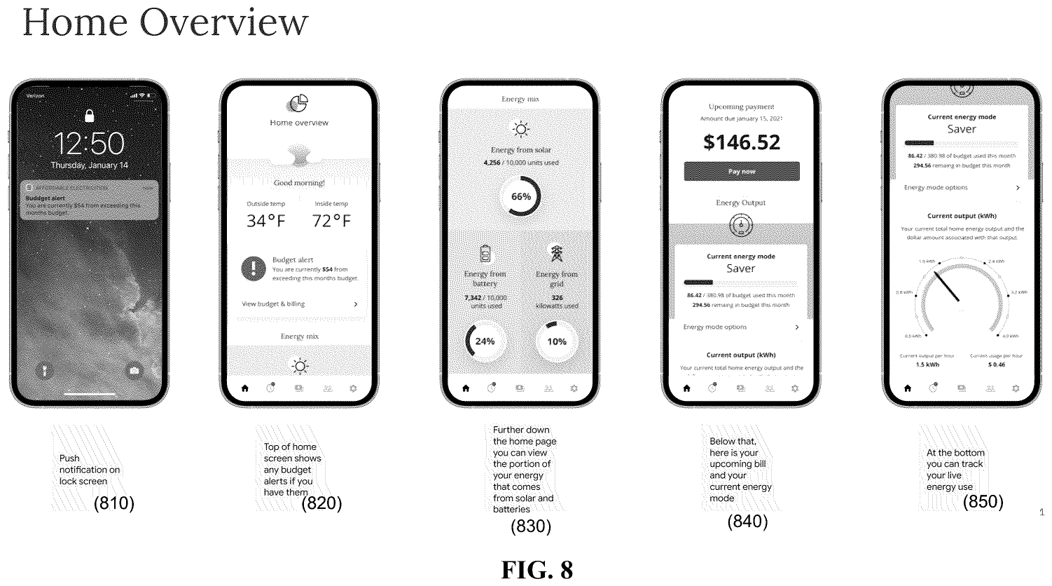

In some embodiments, a home user interface can be provided for energy management. For example, FIG. 8 provides an illustrative example of push notifications for control actions, recommendations, and/or alerts that can be provided to a user on a lock screen of a mobile device executing application 270 at 810, a home screen interface that provides budget alerts at 820, energy usage information for battery and solar sources at 830, billing information and selected energy mode at 840, real-time energy usage information at 850.

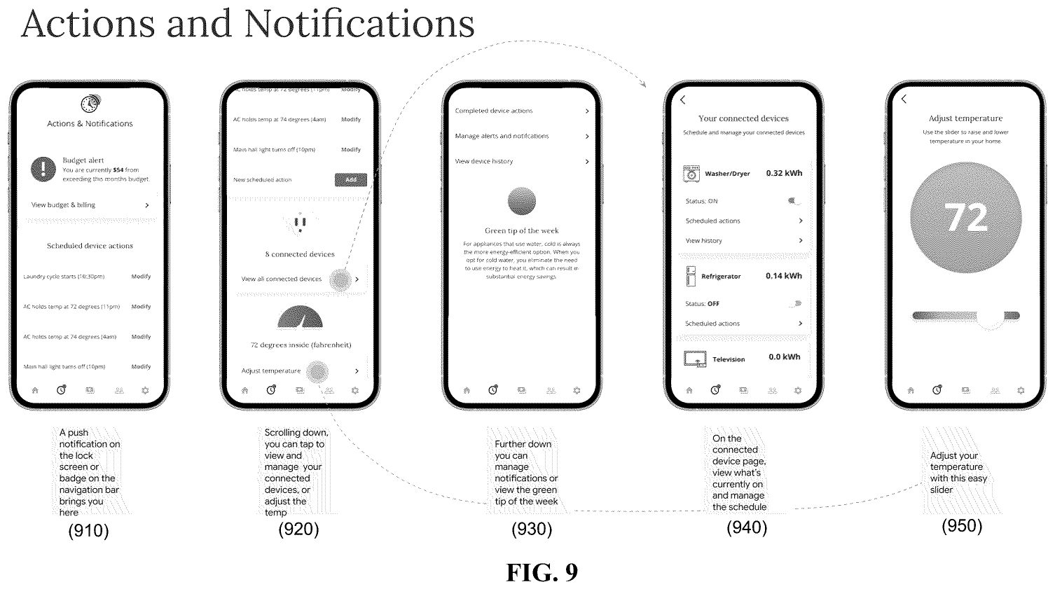

In some embodiments, any suitable action interface elements and notification elements can be provided for energy management. For example, FIG. 9 provides illustrative examples of actions and/or notifications, such as a list of scheduled device actions at 910 in response to selecting the budget push notification at 810 from FIG. 8, managing connected devices in which the user can view devices that are currently on and manage the corresponding schedule and/or scheduled actions at 920 and 940, managing control actions (e.g., adjusting temperature) at 920 and 950, etc. In connection with managing connected devices, the user interface can be provided to control a connected device—e.g., manually turning on and off devices, changing a device operation mode between heating and cooling, adjusting temperature setpoints, overriding automated control actions that will soon be executed, accepting manually energy savings recommendations, etc.

In some embodiments, a user interface can be provided that allows a user to turn on an autopilot mode, which allows the home scheduler system to generate automatic control actions for connected devices in the home. For example, the user interface can indicate the number of connected devices (which can be selected to review and control a selected device), a selected energy mode (e.g., between saver, balanced, and comfort modes), occupancy or vacancy status of the home, and any suitable number of automatic control actions that are being executed. In some embodiments, a user interface can be provided for each controlled device to indicate the device status (e.g., on or off), to provide the ability to manually control the device through the application (e.g., turn on or off), to provide real-time consumption information, and to provide current cost based on current usage (e.g., $0.04).

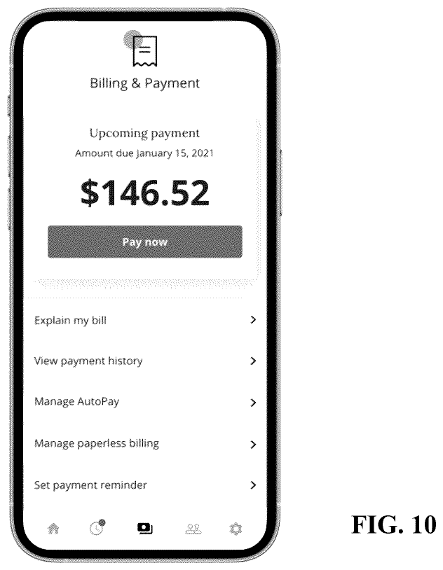

In some embodiments, a user interface can be provided that provides the user with billing information. For example, FIG. 10 provides an illustrative example of a billing page that allows a user to review billing information, payment history, etc.

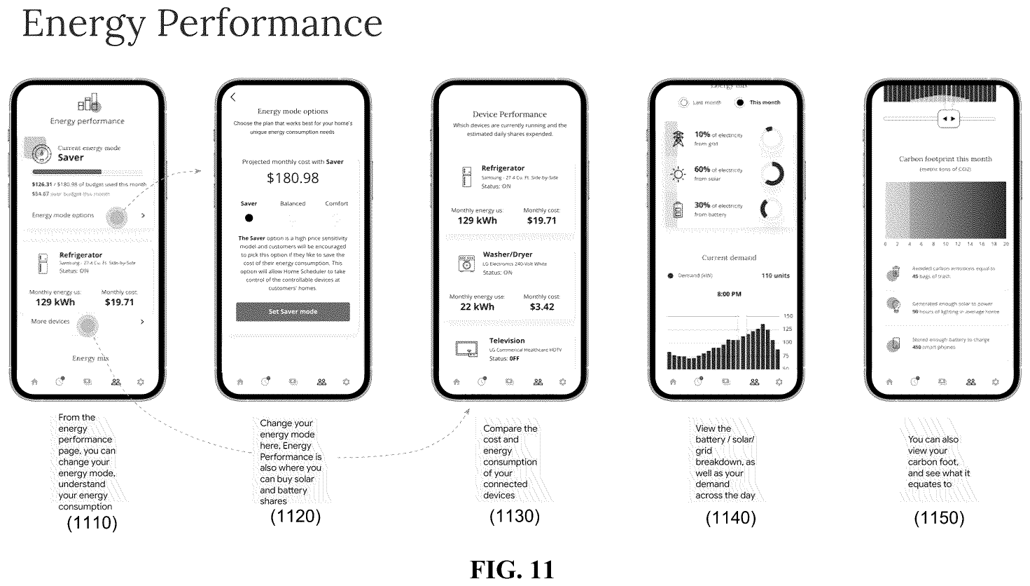

In some embodiments, a user interface can be provided that allows a user to manage energy performance. For example, FIG. 11 provides an illustrative example of an energy performance page that allows the user to change an energy mode and review energy consumption information at 1110, review energy mode options and projected monthly cost with a newly selected energy mode at 1120, compare the cost and energy consumption of connected devices at 1130 (e.g., smart device, operation status, monthly energy use, monthly cost, etc.), view the battery, solar, and grid breakdown as well as current energy demand across a given day at 1140, and/or a carbon footprint representation at 1150. In another example, the energy performance page can track device and meter connectivity and daily, monthly, and yearly energy consumption for each connected device in the home. In yet another example, the energy performance page can provide a device timeline of automatic control actions and an indication of energy consumption savings based on the automatic control actions and/or accepted manual recommendations for non-connected or non-controllable devices. In a further example, the energy performance page can provide recommended actions for uncontrollable devices.

### Vacancy Confidence System

In some embodiments, the system for energy management can include a vacancy confidence system that can determine a vacancy confidence associated with a residential home, where the vacancy confidence can be determined based on live and historical occupancy data. For example, prior to generating automatic control actions for connected devices in the residential home and/or any other suitable intervention described herein, the vacancy confidence system can determine a vacancy confidence level associated with the residential home and, in response to setting the residential home as likely being vacant, one or more interventions can be initiated on the one or more smart devices within the residential home.

Generally speaking, indoor occupancy sensing is not certain even with multiple occupancy sensors (which may be associated a smart device) within a residential home. The lack of sensed occupancy from one or more of these multiple occupancy sensors generally does not equate to a vacant residential home. That is, occupancy sensors can only confirm occupancy, but cannot confirm vacancy. For example, the occupants of the residential home may be asleep or otherwise immobile, the occupants of the residential home may be briefly located in an outdoor area of the residential home in which one of the occupancy sensors is not present, and/or the occupants of the residential home may be located in an area of the residential home that is out of range of one of the occupancy sensors.

It should be noted that the determination of a vacancy confidence can be used in multiple applications. For example, if a residential home is deemed to be vacant based on the vacancy confidence, the connected devices within the residential home can initiate energy saving measures (e.g., the connected devices can be automatically controlled in response to determining that a residential home is vacant based on the vacancy confidence, the connected devices can cause certain energy interventions to not be initiated in response to determining that the vacancy confidence has not met a particular vacancy confidence threshold, etc.). In another example, if a residential home is deemed to be vacant based on the vacancy confidence, an energy management application can prompt a user to initiate an energy saving measure by controlling one or more connected devices.

In some embodiments, the vacancy confidence system can perform a moment-to-moment assessment of vacancy. For example, the vacancy confidence system can determine how long it has been since it was confirmed that an occupant was detected within a residential home with an increasing confidence in a vacancy state over time.

In some embodiments, the vacancy confidence system can query an archive of recorded confirmed occupancy moments (which is sometimes referred to herein as a “learned occupancy schedule”) that compiles confirmed occupancy data. Confirming occupancy can include, for example, occupancy data from an occupancy sensor, occupancy interaction data with a smart device (e.g., a thermostat) or a device controller, IoT device change information corresponding to manual activation or interaction (e.g., power consumption information, change of state information, etc.), AMI meter data change information corresponding to manual activation of a device or appliance not equipped with a smart plug, load controller, or other metering hardware (e.g., power consumption change information in a given time window), geofencing information of an application on a participating mobile device of a resident in the residential home, domestic hot water consumption information (e.g., without an automatic water using device active), etc.

When the vacancy confidence system determines that the moment-to-moment assessment of vacancy indicates that the residential home is likely to be vacant (e.g., due to the period of time since occupancy was last confirmed), the vacancy confidence system can query the archive of recorded confirmed occupancy moments to determine whether this is consistent with this historical data of confirmed occupancy.

It should be noted that, when the vacancy confidence system is corrected (e.g., when a residential home is proven to be occupied shortly after being assumed as likely being vacant), the vacancy confidence threshold or any other suitable value associated with determining the vacancy confidence can be recalibrated for future determinations.

In some embodiments, the vacancy confidence level can be a range between 0 and 0.99, where 0 indicates that the residential home is occupied and where 0.99 indicates the highest vacancy confidence. Upon confirmation of occupancy, the vacancy confidence level can be reset to 0. Otherwise, in response to a particular time unit elapsing since the last occupancy confirmation, the vacancy confidence level can be incremented by a particular value from the current vacancy confidence level. It should be noted that the vacancy confidence level can continue incrementing the vacancy confidence level until occupancy has been confirmed.

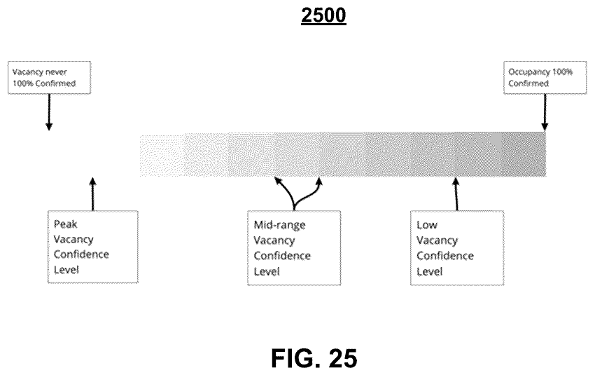

For example, as shown in FIG. 25, the left end of bar graph 2500 shows the highest vacancy confidence level (e.g., 0.99), the middle portion of bar graph 2500 shows a mid-range vacancy confidence level (e.g., 0.5), and the right portion of bar graph 2500 shows a low vacancy confidence level (e.g., 0.1) in which the right end of bar graph 2500 shows that occupancy has been confirmed (e.g., a vacancy confidence level of 0).

It should be noted that the time unit can be adjustable to any suitable time unit and the increment of the vacancy confidence level can be adjustable to any suitable value. For example, the vacancy confidence system can be configured to increase the vacancy confidence level by an increment of 0.05 from the current vacancy confidence level upon 10 minutes elapsing without confirmed occupancy within the residential home. In another example, the vacancy confidence system can be configured to increase the vacancy confidence level by 0.01 from the current vacancy confidence level upon 1 minute elapsing without confirmed occupancy within the residential home.

It should also be noted that occupancy can be determined using any suitable approach and/or any suitable combination of approaches. For example, an occupancy sensor associated with a smart device can directly confirm occupancy based on a detection by the occupancy sensor and, in response to the detection by the occupancy sensor, the vacancy confidence system can reset the vacancy confidence level to 0 and can add the data associated with the detection by the occupancy sensor to the historical occupancy data in the learned occupancy schedule. In another example, an interaction with a thermostat or other device controller of a smart device (e.g., a manual alteration of a setpoint or a physical interaction with smart device) can be deemed as evidence of occupancy of the residential home and, in response to the interaction, the vacancy confidence system can reset the vacancy confidence level to 0 and can add the data associated with the interaction to the historical occupancy data in the learned occupancy schedule. In yet another example, a status change of an installed or monitored device corresponding to manual activation or interaction can be deemed as evidence of occupancy of the residential home and, in response to the status change, the vacancy confidence system can reset the vacancy confidence level to 0 and can add the data associated with the status change to the historical occupancy data in the learned occupancy schedule. In continuing this example, a change in the monitored power consumption of a connected device can indicate a pattern that is altered by an occupant of the residential home (e.g., a hot water heater deviates from standby-loss type behavior indicating hot water has been used, a space heater connected to a smart plug indicates that power consumption has dropped significantly indicating a manual change in setting) can reset the vacancy confidence level to 0 and can add the power consumption data to the historical occupancy data in the learned occupancy schedule. In a further example, the vacancy confidence system can input meter data received from a meter data management system, such as an advanced metering infrastructure (AMI) system, into a machine learning system that identifies a change in power consumption within a given time window that are consistent with manual activation of an appliance or a device within the residential home can be deemed as evidence of occupancy of the residential home and, in response to the identified pattern recognition in power consumption, the vacancy confidence system can reset the vacancy confidence level to 0 and can add the meter data from the meter data management system and/or the data associated with the manual activation of the appliance or the device within the residential home to the historical occupancy data in the learned occupancy schedule.

In some embodiments, the occupancy of a residential home can be determined based on a computing device of a resident that is associated with the system for energy management or the vacancy confidence system. The computing device can be, for example, a mobile device of a resident within the residential home that is executing a mobile application for energy management. In a more particular example, a mobile application can prompt the resident of the residential home to provide authorization to receive location information (e.g., global positioning system information, wireless association information, etc.) and, upon receiving express authorization from the resident, the mobile application can determine, from the location information, whether the resident is located within the residential home. In another example, the interactions by the resident with the mobile application (e.g., providing settings to connected devices) and a prediction that such interactions with the mobile application can be deemed as evidence of occupancy of the residential home. In response to the location information, the vacancy confidence system can reset the vacancy confidence level to 0 and can add the location information to the historical occupancy data in the learned occupancy schedule.

It should be noted that, in situations in which the systems described herein collect personal information about users, or make use of personal information, the users may be provided with an opportunity to control whether programs or features collect user information (e.g., information about a user's preferences or a user's current location). In addition, certain data may be treated in one or more ways before it is stored or used, so that personal information is removed. For example, a user's identity may be treated so that no personal information can be determined for the user, or a user's geographic location may be generalized where location information is obtained (such as to a city, ZIP code, or state level), so that a particular location of a user cannot be determined. Thus, the user may have control over how information is collected about the user and used by a content server.

In some embodiments, in response to the vacancy confidence system determining that a particular decrease in energy consumption (e.g., greater than a threshold decreased amount in overall energy consumption of smart devices within a residential home), the vacancy confidence system can be configured to increment the vacancy confidence level by a greater value (e.g., a significantly large increment, such as 0.5, from the current vacancy confidence level).

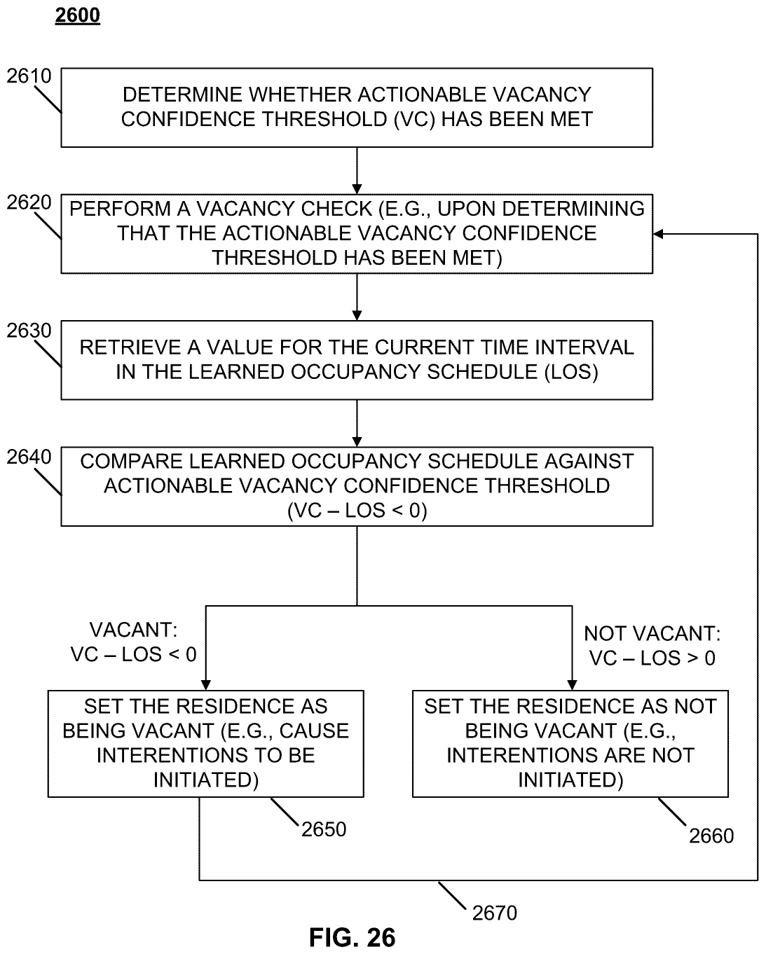

Turning to FIG. 26, an illustrative flow diagram of a process 2600 for determining a vacancy confidence level is shown in accordance with some embodiments of the disclosed subject matter.

Process 2600 can be performed by a vacancy confidence system and can, optionally, be governed by instructions that are stored in a non-transitory computer readable storage medium and that are executed by one or more processors of the vacancy confidence system. Each of the operations shown in FIG. 26 may correspond to instructions stored in a computer memory or non-transitory computer readable storage medium (e.g., a memory of the vacancy confidence system). The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in process 2600 may be combined and/or the order of some operations may be changed.

As described above, the vacancy confidence system can initialize a vacancy confidence level to an initial value. For example, to initialize the vacancy confidence system in which the vacancy confidence level can range between a value of 0 (which indicates a low vacancy confidence level and in which there is a high probability that the residential home is occupied) and a value of 0.99 (which indicates a high vacancy confidence level and in which there is a low probability that the residential home is occupied), the vacancy confidence level can be initialized to a value of 0. As a particular period of time elapses in which occupancy has not been confirmed (e.g., based on an occupancy sensor, occupant interaction with a smart device, device status change information, learned meter information, etc.), the vacancy confidence system can increment the vacancy confidence level. For example, after a configurable time unit of 10 minutes has elapsed, the vacancy confidence system can increment the current vacancy confidence level by a configurable confidence increment of 0.15.

In some embodiments, the vacancy confidence system can include different increments for the vacancy confidence level. For example, upon determining that vacation conditions are present, the vacancy confidence system can be configured to increment the vacancy confidence level by a greater confidence increment (e.g., a significantly large increment, such as 0.5, from the current vacancy confidence level). In a more particular example, vacation conditions can be determined as being present in response to determining a particular decrease in energy consumption (e.g., greater than a threshold decreased amount in overall energy consumption of smart devices within a residential home).

At 2610, process 2600 can determine whether an actionable vacancy confidence threshold has been met. It should be noted that the actionable vacancy confidence threshold can be any suitable value for vacancy confidence between, for example, a value of 0 and a value of 0.99 at which a vacancy check can be executed. For example, process 2600 can retrieve the current vacancy confidence level and can determine whether the current vacancy confidence level meets the actionable vacancy confidence threshold.

In response to determining that the current vacancy confidence level does not meet the actionable vacancy confidence threshold, the vacancy confidence system can continue incrementing the vacancy confidence level by the confidence increment (e.g., 0.15) if occupancy of the residential home has been confirmed. Note that, if occupancy of the residential home has been confirmed (e.g., by one or more occupancy sensors within the residential home), the vacancy confidence level can be reset to a value of 0.

In response to determining that the current vacancy confidence level meets the actionable vacancy confidence threshold at 2610, process 2600 can perform a vacancy check at 2620. The vacancy check can include retrieving a value for the current time interval in the learned occupancy schedule at 2630.

For example, as described above, the learned occupancy schedule is an archive of recorded confirmed occupancy moments that compiles confirmed occupancy data. For example, an occupancy sensor associated with a smart device can directly confirm occupancy based on a detection by the occupancy sensor and, in response to the detection by the occupancy sensor, the vacancy confidence system can add the data associated with the detection by the occupancy sensor to the historical occupancy data in the learned occupancy schedule. In another example, an interaction with a thermostat or other device controller of a smart device (e.g., a manual alteration of a setpoint or a physical interaction with smart device) can be deemed as evidence of occupancy of the residential home and, in response to the interaction, the vacancy confidence system can add the data associated with the interaction to the historical occupancy data in the learned occupancy schedule. In yet another example, a status change of an installed or monitored device corresponding to manual activation or interaction can be deemed as evidence of occupancy of the residential home and, in response to the status change, the vacancy confidence system can add the data associated with the status change to the historical occupancy data in the learned occupancy schedule. In continuing this example, a change in the monitored power consumption of a connected device can indicate a pattern that is altered by an occupant of the residential home (e.g., a hot water heater deviates from standby-loss type behavior indicating hot water has been used, a space heater connected to a smart plug indicates that power consumption has dropped significantly indicating a manual change in setting) can add the power consumption data to the historical occupancy data in the learned occupancy schedule. In a further example, the vacancy confidence system can input meter data received from a meter data management system, such as an advanced metering infrastructure (AMI) system, into a machine learning system that identifies a change in power consumption within a given time window that are consistent with manual activation of an appliance or a device within the residential home can be deemed as evidence of occupancy of the residential home and, in response to the identified pattern recognition in power consumption, the vacancy confidence system can add the meter data from the meter data management system and/or the data associated with the manual activation of the appliance or the device within the residential home to the historical occupancy data in the learned occupancy schedule.

In continuing this example, the learned occupancy schedule can be a cumulative occupancy status archive compiled with historical occupancy data. That is, using historical indications of occupancy, a schedule of expected occupancy can be established. This can, for example, be a check or reference for the current live status assessed in the residential home from different data sources. When the current live status from the residential home and the archived data are in agreement (e.g., current assessment of vacancy status aligns with past status), this provides a greater degree of assurance that the prediction of vacancy in the residential home is correct.

For each time interval, historical occupancy confirmation data can be averaged to provide a value between 0.01 and 1, where a value of 1 indicates confirmed occupancy at a historical time interval and where other values indicate the inverse of the vacancy confidence at that historical time interval. For example, when occupancy is confirmed using any suitable approach and/or any suitable combination of approaches described above, the learned occupancy schedule can be a value of 1.0. In another example, if the historical occupancy confirmation data is averaged (e.g., total score divided by the number of time intervals), an average historical occupancy status can be provided for that historical time interval. That is, the expected occupancy can be forecast to a value between 0.01 and 0.99. It should be noted that the learned occupancy schedule value can be improved as data is received and stored in the learned occupancy schedule.

In some embodiments, particular time intervals can be assigned a weight. For example, more recent data stored in the learned occupancy schedule can be assigned a higher weight in the determination of the archived score for the time interval.

At 2640, the vacancy confidence system can compare the value from the learned occupancy schedule at the particular time interval against the current actionable vacancy confidence threshold that was met at 2610. For example, the vacancy confidence system can determine whether the residential home is likely to be vacant by subtracting the value for the actionable vacancy confidence threshold (VC) from the value in the learned occupancy schedule (LOS).

If the comparison result is greater than 0, the current vacancy confidence level is greater than the learned occupancy schedule's expectation of occupancy and the vacancy confidence system can set the residential home as likely not being vacant at 2660. In response to setting the residential home as likely not being vacant, one or more interventions may not be initiated.

If the comparison result is less than 0, the current vacancy confidence level is greater than the learned occupancy schedule's expectation of occupancy and the vacancy confidence system can set the residential home as likely being vacant at 2650. In response to setting the residential home as likely being vacant, one or more interventions can be initiated. As described herein, the one or more interventions can include, for example, automatically turning off one or more smart devices, automatically adjusting setpoints for one or more smart device, etc.

In turn, at 2670, the vacancy confidence system can return to 2620 and continue to perform the vacancy check in the next and subsequent time intervals if the vacancy confidence level continues to be above the actionable vacancy threshold value. This can, for example, allow an increasing expectation of occupancy on the part of the learned occupancy schedule to override the vacancy confidence level within the vacancy check, assume occupancy, and cease performing interventions with the smart devices within the residential home based on assumed occupancy.

In some embodiments, the vacancy confidence system can be corrected at times. For example, upon reset of the vacancy confidence level within a short time period after interventions have been made with the smart devices within the residential home based on an assumption of vacancy and prior to the learned occupancy schedule resetting the vacancy confidence level, the vacancy confidence system can modify the actionable vacancy confidence threshold value. In a more particular example, upon reset of the vacancy confidence level within a short time period (e.g., five minutes or any other suitable user-configurable time value) after interventions have been made with the smart devices within the residential home based on an assumption of vacancy and prior to the learned occupancy schedule resetting the vacancy confidence level, the vacancy confidence system can modify the actionable vacancy confidence threshold value by 50% of the difference between the current actionable vacancy confidence threshold value and the highest actionable vacancy confidence threshold value of 0.99.

### Dynamic Rate Engine

Generally speaking, the dynamic rate engine, such as dynamic rate engine 266 in FIG. 2, can be a system that generates a variable, hourly electricity rate that changes in accordance with community demand to give residential customers a reflection of the true cost of electricity consumption at that hour. It should be noted that such a dynamic rate can include all of the conventional electricity tariff charges that a residential customer typically pays with the difference that all of the cost components vary by hour to reflect real-time conditions in the wholesale market and on the grid (e.g., demand relative to available infrastructure capacity).

This dynamic rate engine can, for example, offer utility providers an electricity pricing structure that incentivizes residential load shifting and shaving and can be deployed to reduce the utility's commodity and infrastructure costs and carbon emissions. Such savings can flow through to the utility's residential customers over time.

It should also be noted that, while the difference in cost of the dynamic rate determined by the dynamic rate engine to that of a flat rate or time of use rate can vary by the hour and day, the dynamic rate can be revenue neutral relative to a flat rate or time of use rate for the utility.

Current residential electricity tariffs in the United States generally include commodity costs and transmission and distribution (T&D) costs. Commodity costs cover the cost of the electricity procured by the utility provider or retail electricity service provider on behalf of residential customers. In traditional tariffs, this commodity cost is set for residential customers at a predetermined $/kilowatt-hour (kWh) rate through the regulatory process and incorporates (but does not convey to the residential customer) the real-time wholesale market value of that electricity. In a flat rate tariff, the price can be the same for a residential customer at all hours of the day. In a time of use (TOU) rate, the commodity $/kWh price can vary by time of day and often seasonally (e.g., peak, mid-peak and off-peak, summer, winter, etc.). In some jurisdictions, the commodity price in the residential tariff can vary hourly. Turning to T&D costs, this portion of the residential tariff covers the utility provider's transmission, distribution, and administration costs. In a traditional residential tariff, a portion of the T&D cost is calculated based on the residential customer's monthly electrical energy usage (measured in kWh) and another portion of the T&D cost is fixed and applied equally to all residential customers (e.g., $/meter).

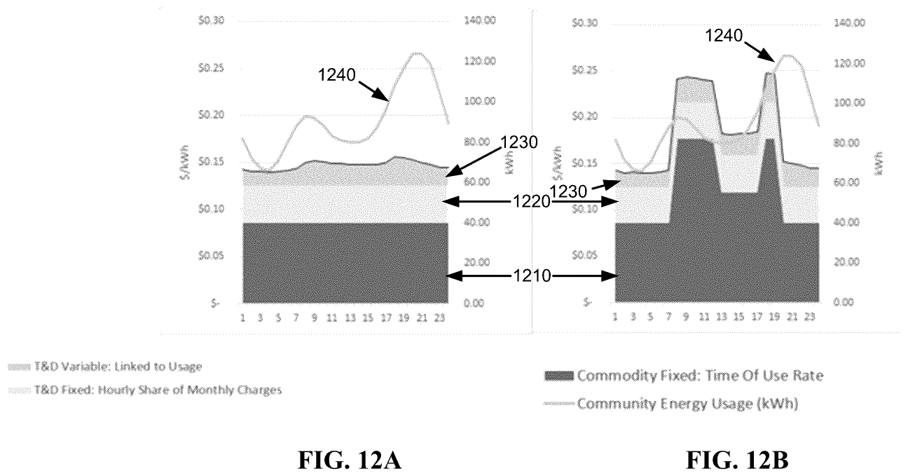

For an identical customer daily load profile, an illustrative example of a flat rate tariff is shown in FIG. 12A and an illustrative example of a time of use (TOU) rate tariff is shown in FIG. 12B. As shown, each residential tariff includes a fixed commodity cost 1210, a fixed T&D cost 1220 that is applied equally to all residential customers, and a variable T&D cost 1230 that is calculated based on the residential customer's monthly electrical energy usage (which is shown by line 1240).

In some embodiments, the dynamic rate engine can incorporate an additional settlement cost category to the commodity cost and the T&D cost.

For example, unlike traditional residential tariffs where the commodity pricing is fixed for residential customers, the commodity cost in the dynamic rate can vary hourly to better track the wholesale price of electricity or the price that the utility provider paid for the electricity. In continuing this example, the commodity cost in the dynamic rate can be forecasted for each hour of a month in advance and then revised hourly. It should be noted that the monthly forecast of the commodity cost can be determined using a combination of historical market data, weather forecasts for the upcoming month, and machine learning and can be updated daily with day-ahead forecasts from an independent electricity system operator. The forecast can be updated every hour (or any other suitable time interval) as new data becomes available and weather forecasts are improved.

In another example, the T&D cost in the dynamic rate can also be forecasted for each hour of a month in advance and updated every hour based upon updated information. The T&D portion of the hourly rate can be a weighted share of the utility provider's total forecasted T&D cost to residential customers for that month. Such weighting can be based upon the predicted total community demand for electricity at that hour in the month relative to the total aggregate demand for the month. Accordingly, if community demand is forecast to be high for that particular hour, the T&D cost can be relatively high. Alternatively, if community demand is forecast to be low for that particular hour, the T&D cost can be relatively low.

In a more particular example, the T&D cost for a particular hour can be calculated using any suitable approach. For example, the total T&D collection for the month can be calculated by:

(A×B)+(C×D)=E

where A is the forecasted community energy use for the month (in kWh), B is the tariffs variable T&D charges (in $/kWh), C is the number of meters in a community, D is the tariffs fixed T&D charges (in $/meter), and E is the total T&D collection for the month (in $).

The weighting for any hour can be determined as follows:

Z₁÷A=F

where Z₁ is the forecasted community energy use for a specific hour Z1 in the month (in kWh), A is the forecasted community energy use for a month (in kWh/hr), and F is the T&D weighting for hour Z1.

The forecasted revenue for that same hour can be determined by:

E×F=G

where E is the total T&D collection for the month (in $), F is the T&D weighting for hour Z1, and G is the forecasted T&D revenue for hour Z1 (in $).

It should be noted that the variance between the forecasted commodity price for an hour and the actual price, as well as the variance between forecasted demand (as electrical demand is the basis for the distribution of the T&D charges) and actual demand, can lead to the utility provider under- or over-collecting for a particular hour. This variance can be settled over the remaining hours in the month in a manner that is proportional to the community's forecasted demand and in such a manner that it does not distort the price significantly.

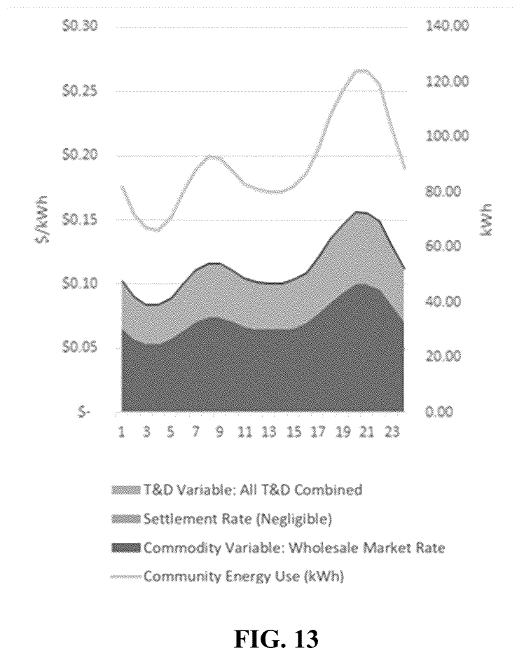

An illustrative example of a dynamic rate for the same daily residential customer load curve is shown in FIG. 13.

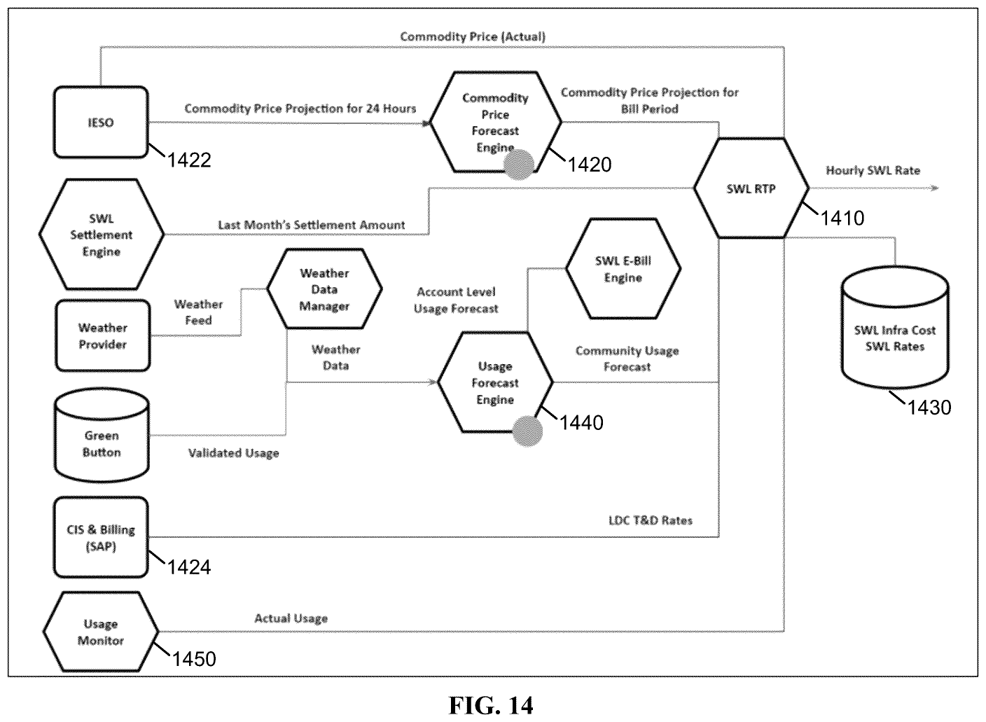

FIG. 14 shows an illustrative flow diagram for the dynamic rate engine in accordance with some embodiments of the disclosed subject matter. As shown, dynamic rate engine 1410 can receive inputs from multiple sources. Dynamic rate engine 1410 can dynamically calculate a dynamic rate of electricity for every hour based upon the forecasted wholesale price of electricity, delivery and regulatory charges (e.g., via commodity price forecast engine 1420, independent electricity service operator (IESO) 1422, and CIS & Billing 1224) in proportion to the forecasted community consumption per hour (e.g., via usage forecast engine 1440). The forecasted wholesale price of electricity, delivery and regulatory charges can, in some embodiments, include a forecasted commodity price feed from IESO 1422, an actual commodity price feed from IESO 1422, and delivery and regulatory charges for residential customers. Additionally, dynamic rate engine 1410 can receive monthly settlement amounts from a settlement engine, validated historical usage data from a utility provider platform, and weather forecast data from a weather provider source.

In some embodiments, dynamic rate engine 1410 can derive data using the received inputs. For example, as shown in FIG. 14, commodity price forecast engine 1420 can estimate an hourly commodity price for a particular billing period based on historical commodity price, historical provincial demand, and forecasted provincial demand. In another example, as also shown in FIG. 14, usage forecast 1440 can derive a usage forecast using predictive modeling of customer behavior based on validated historical consumption data from a utility provider platform and weather forecast data from a weather provider source.

The dynamic rate can be adjusted by dynamic rate engine 1410 at particular time intervals (e.g., every hour) based on the actual energy usage received from a utility provider (e.g., via usage monitor 1450).

In some embodiments, an application executing on a computing device can receive the dynamic rate along with input data and/or derived data used to calculate the dynamic rate and can present one or more user interfaces. An illustrative example of a dashboard user interface is shown in FIG. 15 in which price trends and forecasts, the compositions of those prices, and the monthly spread between the highest and lowest price are provided.

### Electronic Billing System

Generally speaking, the electronic billing system, such as electronic billing system 262 in FIG. 2, can be a system that allows residential customers to access and engage with home energy usage data and billing data in real-time, as well as purchase shares in community solar and battery assets.

In some embodiments, the electronic billing system can receive any suitable input, such as energy consumption data and the hourly price of electricity generated by the dynamic rate engine (e.g., dynamic rate engine 266 in FIG. 2).

In some embodiments, upon receiving the above-mentioned inputs, the electronic billing system can determine real-time energy consumption, cost, and savings at the device level (e.g., using the communication gateway to connected devices) and the home level and the historic energy consumption, cost, and savings (e.g., from the past month, from the same time as last year, etc.), total energy consumption, cost, and savings, and forecasted energy consumption, cost, and savings for the current billing cycle.

In some embodiments, the solar and battery shares system, such as solar and battery shares system 264 in FIG. 2, can be incorporated within the electronic billing system to provide residential users with the opportunity to access the economic and environmental benefits of community renewable energy generation and energy storage.

The energy cost and solar and battery information can be consumed by the electronic billing system to provide the residential user with multiple features using a mobile application.

For example, a mobile application associated with the electronic billing system can allow the residential user to set a monthly budget. In continuing this example, the electronic billing system can provide a target budget for each of multiple energy modes (e.g., a saver mode, a balanced mode, and a comfort mode) based on the forecasted energy cost for that month for each energy mode, where the forecasted energy cost for each energy mode can be tailored and specific to the residential user based on history energy consumption patterns (e.g., previous monthly consumption, previous energy consumption multiplied by the determined dynamic rate, etc.). Using the mobile application, a residential user can select one of the energy modes depending on how aggressively the residential user wants to conserve energy and cost.

In another example, the mobile application associated with the electronic billing system can provide the residential user with an opportunity to purchase shares of neighborhood solar and/or battery assets. In continuing this example, the electronic billing system can recommend the number of solar and/or battery shares for a residential user based on the number of shares made available for that month and based on the forecasted usage pattern for the residential user. It should be noted that, in some embodiments, the price for purchasing shares of neighborhood solar and/or battery assets can vary—e.g., based on the number of shares available for purchase, based on the minimum share size, based on the maximum share size, etc. It should also be noted that, in some embodiments, the electronic billing system can use the mobile application to provide the total cost for purchasing a certain number of shares of neighborhood solar and/or battery assets and a projected savings amount associated with purchasing the certain number of shares of neighborhood solar and/or battery assets.

In yet another example, the mobile application associated with the electronic billing system can provide the residential user with the ability to monitor the current hourly and cumulative energy use (in kWh) and cost (in $ based on the determined dynamic rate) of each monitored device and of the total for the residential home.

In a further example, the mobile application associated with the electronic billing system can provide the residential user with the ability to track the total amount of savings associated with energy management interventions executed by the home scheduler system (e.g., powering off a particular device, decreasing an amount in which an HVAC device is used, etc.) and based on the solar and battery shares purchased for that month. In continuing this example, the mobile application associated with the electronic billing system can provide the residential user with the ability to track the residential user's progress against a monthly budget by estimating the user's total predicted cost for the month. Additionally, the mobile application associated with the electronic billing system can provide the residential user with the ability to compare the current or predicted energy cost for the month against historical energy costs from previous months.

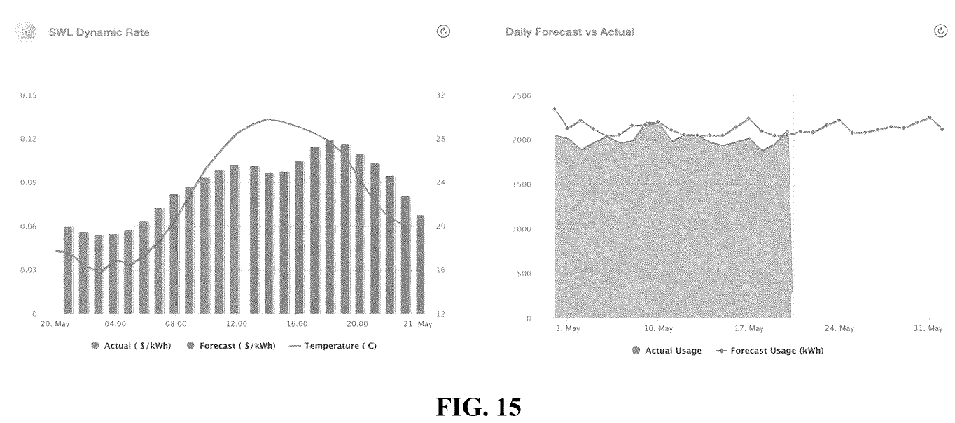

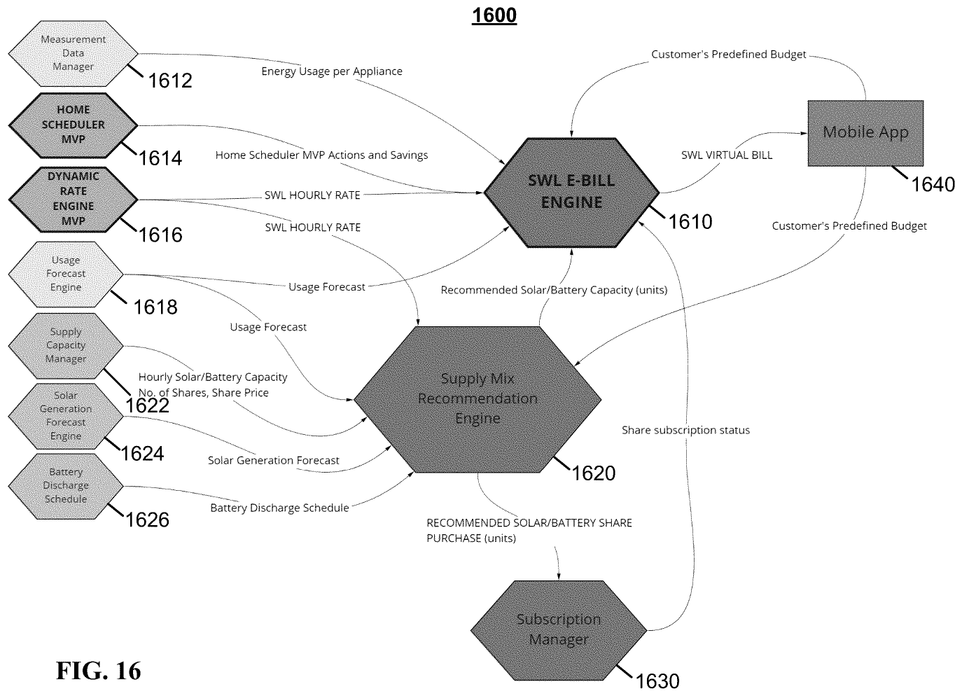

Turning to FIG. 16, an illustrative flow diagram of an electronic billing system 1600 is shown in accordance with some embodiments of the disclosed subject matter. As shown, the electronic billing system can include multiple components, such as electronic billing engine 1610, recommendation engine 1620, and subscription manager 1630.

Similar to the home scheduler system described above, electronic billing system and its components can receive inputs from multiple sources.

For example, as shown in FIG. 16, electronic billing engine 1610 can receive energy consumption data from measurement data manager 1612 or any other suitable source. Such energy consumption data can include (i) device level energy consumption data that can be received from one or more smart devices in one hour increments and, in some implementations, can be transmitted to a communication gateway between the in-home devices and home scheduler system 1614, (ii) home energy consumption data that can be captured by a smart meter device in one minute increments and, in some implementations, can be transmitted to a communication gateway between the smart meter device and home scheduler system 1614, (iii) home energy consumption data that can be captured using an advanced metering infrastructure and transmitted to measurement data manager 1612 (e.g., with a lag of between one hour and eight hours); and/or (iv) forecasted energy consumption data generated from a usage forecast engine 1618 and transmitted to measurement data manager 1612 in which usage forecast engine 1618 uses machine learning techniques to determine minimum, average, and maximum consumption estimates for each hour at the beginning of each month. It should be noted that, in some embodiments, energy consumption data can be transmitted directly from a component, such as usage forecast engine 1618, to electronic billing engine 1610. Additionally or alternatively, energy consumption data can be transmitted from a component, such as usage forecast engine 1618, to measurement data manager 1612, where measurement data manager 1612 transmits the energy consumption data to electronic billing engine 1610.

In some embodiments, electronic billing engine 1610 can receive inputs, such as home scheduler actions and savings, from home scheduler system 1614. In a more particular example, the communication gateway or any other suitable device adapter can collect data wirelessly from connected devices and a smart meter and can package and transmit that data to the home scheduler system. The communication gateway can also receive control actions, such as automated actions for a connected device, and can communicate the control actions to a connected device. As such, the communication gateway can provide electronic billing engine 1610 with energy consumption data on a device level along with automated control actions that have been performed and automated control actions that have been declined or overridden.

In some embodiments, electronic billing engine 1610 can receive inputs, such as the current and forecasted hourly price of electricity from a dynamic rate engine 1616. This can include, for example, a variable, hourly electricity rate that changes in accordance with community demand to give residential customers a reflection of the true cost of electricity consumption at that hour. In another example, such inputs can include historic energy consumption and cost data from past months based on advanced metering infrastructure data, where historical energy consumption and cost data can include historical energy usage and historical dynamic rates applied to prior energy usage.

It should be noted that, in some embodiments, upon determining that one of the data inputs described above is unavailable, electronic billing engine 1610 can attempt to obtain such data after a specified amount of time (e.g., set in a configuration file). In continuing this example, if any of the above-mentioned data inputs is determined to be unavailable (e.g., after a particular number of attempts to obtain such data), electronic billing engine 1610 can generate a process exception in a log. Upon determining that a sufficient amount of data has been obtained, electronic billing engine 1610 can begin processing and/or analyzing the received input data.

In some embodiments, electronic billing system 1610 and/or recommendation engine 1610 can receive inputs from solar and battery shares system, such as solar and battery shares system 264 in FIG. 2. Such inputs can include (i) hourly solar and battery capacity information, number of shares available for purchase, and the share price for solar and battery shares from a supply capacity manager 1622, (ii) solar generation forecast information from a solar generation forecast engine 1624, and (iii) battery discharge schedule information from a battery discharge schedule 1626.

In some embodiments, electronic billing engine 1610 can use this energy consumption data and other inputs to generate a customized bill for each residential user based on the dynamic rate. This bill can, for example, provide the residential user with detailed insight into the impact of their energy consumption patterns down to real-time device level consumption. In a more particular example, electronic billing engine 1610 can generate a bill that provides the residential user with an indication of how manual and/or automatic interventions have impacted energy costs (e.g., reduced energy costs in accepted interventions, increased energy costs in refused interventions, etc.). In continuing this example, electronic billing engine 1610 can generate a bill that provides the residential user with an indication of how much each refused intervention increased energy costs and an indication of how much each accepted or automatically performed intervention decreased energy costs.

It should be noted that electronic billing engine 1610 can compute the hourly cost, total cost-to-date, forecasted cost, and the total predicted monthly energy cost for each residential user as well as savings generated by automatic device control and solar and battery shares for the upcoming billing period. Such savings can include, for example, projected savings, actual savings, and/or greenhouse gas emission savings.

It should also be noted that electronic billing engine 1610 can update the hourly cost, total cost-to-date, forecasted cost, and the total predicted monthly energy cost for each residential user as well as savings generated by automatic device control and solar and battery shares for the upcoming billing period at any suitable time, such as five minutes after every hour. For example, the cost and savings outputs from electronic billing engine 1610 can be displayed in the mobile application. In another example, the cost and savings outputs from electronic billing engine 1610 can be transmitted to the home scheduler system such that the home scheduler system can determine whether an automatic device control should be taken based on how the residential user is tracking towards a targeted budget (e.g., a budget indicated by a residential user using mobile application 1640).

Cost calculations by electronic billing engine 1610 can be represented as follows:

Hourly Cost=Hourly Energy Consumption×Hourly Price

Total Cost to Date (for Billing Period)=Σ(Hourly Cost)

Forecasted Cost=Forecasted Hourly Energy Consumption×Forecasted Hourly Price

Predicted Monthly Cost=Cost to Date+Forecast Cost−Net Savings

It should be noted that the forecasted hourly energy consumption in the calculation of forecasted cost can be calculated for the remainder of the month based on the residential user's selected energy mode. In continuing this example, if the residential user changes the selected energy mode in the middle of a billing cycle, the forecasted hourly energy consumption can adjust up or down accordingly. It should also be noted that the predicted monthly cost can be used to determine whether or not the residential user is tracking towards a targeted budget and, accordingly, whether or not the residential user should receive automated device control actions or other interventions.

Savings calculations performed by electronic billing engine 1610 can be represented as follows:

Total Accumulated Savings=Automatic Device Control Savings+Solar and Battery Share Savings

Projected Savings=Forecasted Solar and Battery Generation Savings

Net Savings=Total Accumulated+Projected Savings

In some embodiments, recommendation engine 1620 can compute the recommended amount of solar and battery shares to be purchased by the residential user for that billing cycle. Recommendation engine 1620 can receive forecasts and data from multiple sources to make this assessment of the recommended amount of solar and battery shares to be purchased by the residential user. The recommendation can be based on the total number of shares available, as determined by the solar and battery shares system, such as solar and battery system 264, by the total forecasted energy consumption for the account for that month, where residential users with higher forecasted consumption can be recommended more shares. It should be noted that this recommendation engine 1620 can run on the last day of the billing period for the following billing period, and the recommendation can be sent to subscription manager 1630.

In some embodiments, subscription manager 1630 can calculate a target budget for each residential user at each month and can present the availability of solar and battery shares to a residential user. Once solar and battery shares are purchased, subscription manager 1630 can communicate the number of purchased shares back to electronic billing engine 1610.

Accordingly, the electronic billing engine 1610 can use the above-mentioned inputs (e.g., energy usage information per appliance, home scheduler actions, dynamic rate, usage forecast information), recommended solar and battery capacity information from recommendation engine 1620, and/or share subscription status information from subscription manager 1630 to generate an electronic bill for review by the residential user using mobile application 1640. Electronic billing engine can determine real-time energy consumption, cost, and savings at the device level (e.g., using the communication gateway to connected devices) and the home level and the historic energy consumption, cost, and savings (e.g., from the past month, from the same time as last year, etc.), total energy consumption, cost, and savings, and forecasted energy consumption, cost, and savings for the current billing cycle.

In some embodiments, a residential user can interact with electronic billing engine 1610 using mobile application 1640.

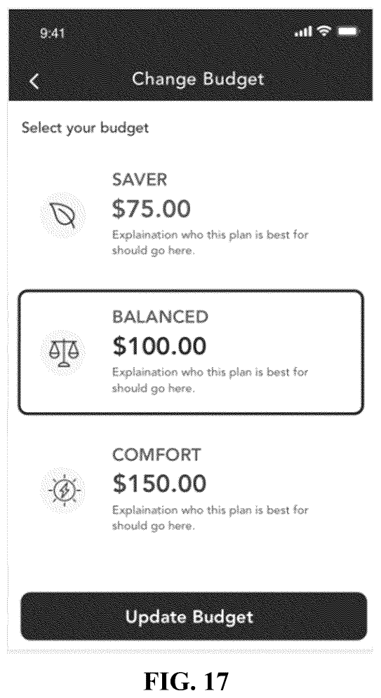

For example, as shown in FIG. 17, mobile application 1640 associated with the electronic billing engine 1610 can allow the residential user to select an energy mode, such as a saver mode in which a maximum number of automated control actions or interventions can be performed and a comfort mode in which a minimum number of automated control actions or interventions can be performed. In continuing this example, as also shown in FIG. 17, mobile application 1640 can present a target budget for each of multiple energy modes (e.g., $75.00/month for a saver mode, $100.00/month for a balanced mode, and $150.00/month for a comfort mode) that were determined based on the minimum, average, and maximum forecasted energy consumption received from usage forecast engine 1618. Subscription manager 1630 can transmit these target budgets to mobile application 1640 for user selection. The selected target budget, selected energy mode, and other user selections can be transmitted to home scheduler system 1614 to inform automatic control actions for that user.

In a more particular example, mobile application 1640 can present an interface that prompts the residential user to select between a comfort mode, a balanced mode, an energy saver mode, and any other suitable modes. Additionally, in some embodiments, mobile application 1640 can present the projected monthly cost for each energy mode. In response to receiving a selected mode, the associated projected monthly cost is the target budget for the billing cycle. It should be noted that the selected energy mode can be set as a default mode for each month until the user selects another energy mode. For example, as shown in FIG. 17, mobile application 1640 can allow the user to select a different energy mode and select a user interface to update the target budget for the residential user.

In some embodiments, for each energy mode, mobile application 1640 can provide the residential user with an opportunity to tune an energy mode to modify a target budget. For example, a slider interface can be provided in mobile application 1640 in which the residential user can modify a number of automatic interventions (e.g., between a maximum number of interventions for a balanced mode and a minimum number of interventions for the balanced mode). In another example, interface elements can be provided in mobile application 1640 in which the residential user can select particular devices that are eligible for automatic intervention (e.g., HVAC devices, smart appliances, etc.). In response to receiving selections in the slider interface and/or the interface elements, a targeted budget can be updated by subscription manager 1630. Alternatively, in some embodiments, mobile application 1640 can inhibit the residential user from modifying the target budget or the projected costs for each energy mode.

In some embodiments, the residential user can execute mobile application 1640 on a suitable mobile device to access the electronic billing system to monitor energy consumption in comparison with a target budget for a selected mode, to monitor hourly energy consumption, costs, and savings data.

In some embodiments, mobile application 1640 can transmit a notification to the residential user that energy consumption is approaching a target budget, a notification to the residential user that energy consumption has exceeded a target budget, a notification to the residential user that an energy mode or other energy usage parameters should be changed based on the energy consumption compared with the target budget.

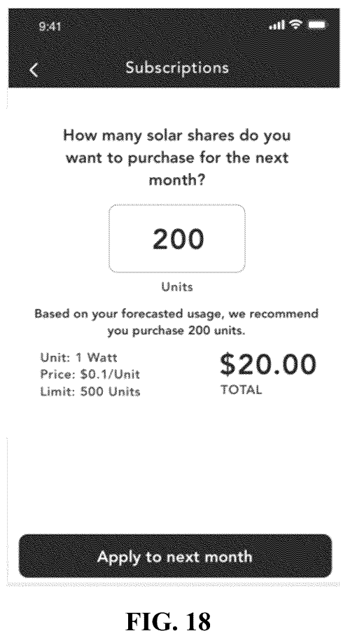

In some embodiments, mobile application 1640 can provide the residential user with an opportunity to purchase shares of neighborhood solar and/or battery assets. For example, as shown in FIG. 18, mobile application 1640 can present an interface that recommends the number of solar and/or battery shares for a residential user based on the number of shares made available for that month and based on the forecasted usage pattern for the residential user. It should be noted that, in some embodiments, the price for purchasing shares of neighborhood solar and/or battery assets can vary—e.g., based on the number of shares available for purchase, based on the minimum share size, based on the maximum share size, etc. It should also be noted that, in some embodiments, the electronic billing system can use mobile application 1640 to provide the total cost for purchasing a certain number of shares of neighborhood solar and/or battery assets and a projected savings amount associated with purchasing the certain number of shares of neighborhood solar and/or battery assets. In response to selecting a particular number of solar and/or battery shares (e.g., up to a particular share limit), mobile application 1640 can present the projected savings and total cost for the purchase (e.g., $20.00 total) and the total cost of purchased shares can be added to the cost-to-date for the billing cycle.

It should be noted that the residential user can be provided with the opportunity to purchase solar and/or battery shares at any time during the billing cycle.

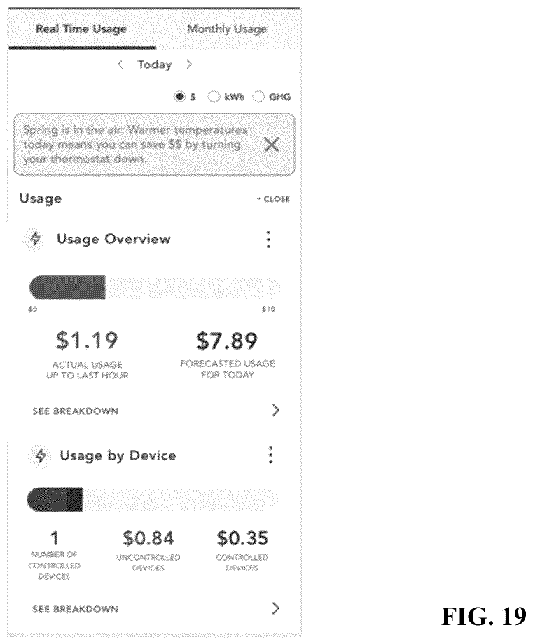

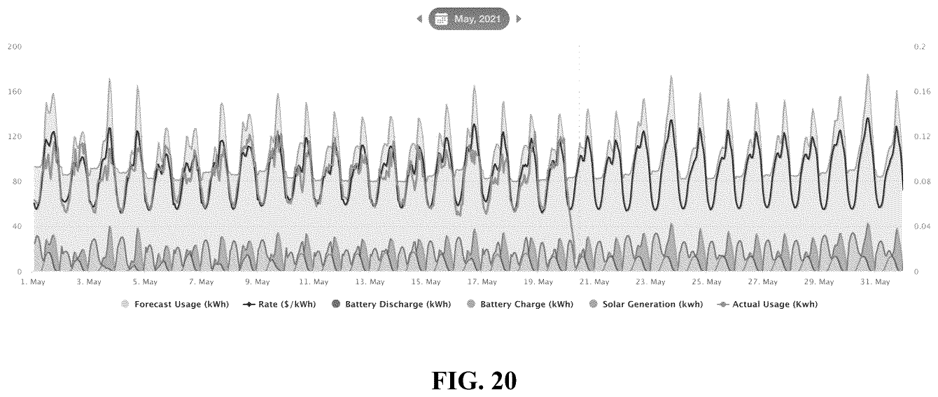

In some embodiments, mobile application 1640 can provide the residential user with an opportunity to monitor the current hourly and cumulative energy (in kWh) and cost (in $ based on the determined dynamic rate) of each monitored device and of the total for the residential home. For example, as shown in FIG. 19, mobile application 1640 can present an interface that provides one or more recommendations (e.g., save on energy costs by turning a thermostat down), actual usage (e.g., up to the last hour), forecasted usage for the current day, usage by device (e.g., the number of controlled devices with a breakdown of energy usage for uncontrolled devices in comparison with energy usage of controlled devices), etc. In a more particular example, mobile application 1640 can present a percentage of energy that has been provided from different sources for each individual user, such as grid, solar, and battery, based on the output of purchased shares. It should be noted that the supply mix can be presented at both the individual and community level. An illustrative example of community level energy performance is shown in FIG. 20.

In some embodiments, mobile application 1640 can provide the residential user with an opportunity to view a breakdown of energy usage on a device level. For example, mobile application 1640 can provide interfaces that show energy usage by each device (e.g., such that the residential user can understand which devices consume the most electricity). In another example, mobile application 1640 can provide interfaces that show energy savings associated with energy management interventions executed by the home scheduler system (e.g., powering off a particular device, decreasing an amount in which an HVAC device is used, etc.) and based on the solar and battery shares purchased for that month.

### Solar and Battery Transaction System

Generally speaking, the solar and battery transaction system, such as solar and battery transaction system 264 in FIG. 2, can be a system that facilitates the purchase of prepaid shares of community-sited solar photovoltaic and battery capacity to a residential user in order to reduce bills and insulate the residential user from the higher cost of peak time electricity use. The solar and battery transaction system can combine solar generation and battery discharge to determine the effect on the aggregated community demand and the allocation of shares to individual customers. Accordingly, the solar and battery transaction system can manage solar and battery capacity and the number of shares available to residential users in the community and manage the pricing of such solar and battery shares.

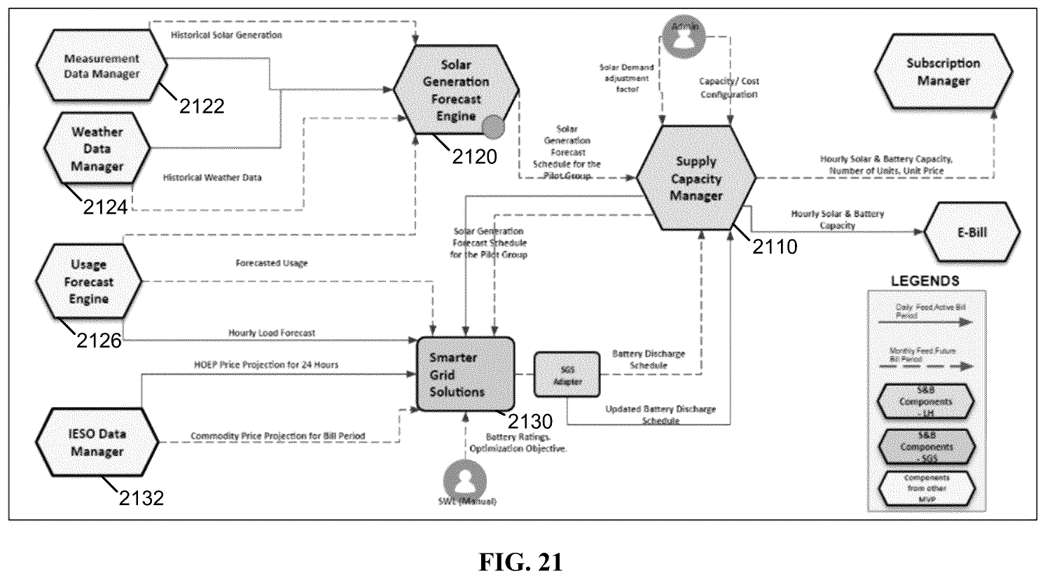

For example, as shown in FIG. 21, supply capacity manager 2110 can receive various inputs to generate the total solar capacity at the community level, the total battery capacity at the community level, the total solar supply units at the community level, the total battery supply units at the community level, the unit price of solar supply capacity, and the unit price of battery supply capacity.

To generate these outputs, supply capacity manager 2110 can receive a solar generation forecast schedule from a solar generation forecast engine 2120, which generates the solar generation forecast schedule based on historical solar generation information from a measurement data manager 2122, historical weather data from a weather data manager 2124, and forecasted usage information from a usage forecast engine 2126.

In addition, supply capacity manager 2110 can transmit a solar generation forecast schedule to a battery discharge schedule provider system 2130 and, in response, receives a battery discharge capacity for each hour of a billing period in kilowatts before the beginning of the billing period and a daily battery discharge schedule during the billing period. Note that, in addition to the solar generation forecast schedule from supply capacity manager 2110, battery discharge schedule provider system 2130 can receive additional data, such as forecasted usage information from usage forecast engine 2126, forecasted electricity price information from IESO data manager 2132.

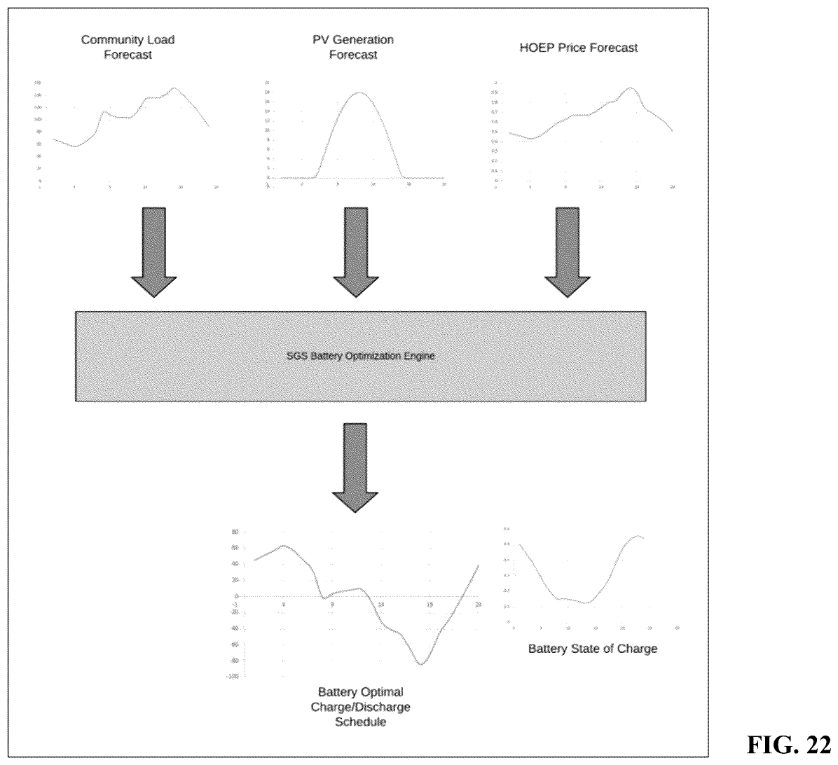

It should be noted that, in some embodiments, the solar and battery transaction system can include a battery optimization service that can determine an optimal charge/discharge schedule for a battery energy storage system that can include any suitable number of batteries and inverters. As shown in FIG. 22, the battery optimization service can receive community load forecast information (e.g., total load of residential users in a smart community predicted at an hourly interval and measured in kW), solar generation forecast information (e.g., a stochastic forecast of solar generation at a community solar site predicted at an hourly interval and measured in kW), and electricity price forecast information (e.g., a price forecast generated by an IESO) to determine an optimal charge/discharge schedule for the battery energy storage system. The battery optimization service can level the net load of the community, where the net load of the community is generally equivalent to the difference of the community load forecast and the solar generation forecast. To level the net load forecast, the battery optimization service can discharge the battery when the net load is above its 24-hour average (or any other suitable threshold) and charge the battery when the net load is below the 24-hour average (or any other suitable threshold). Additionally, the battery optimization service can minimize the net demand of the community at times of peak electricity pricing by analyzing the electricity price forecast information and prioritizing battery discharge during times of peak electricity pricing.

In some embodiments, supply capacity manager 2110 can also receive configurable parameters, such as cost configuration information (e.g., per kW cost of solar capacity, per kW cost of battery capacity) and a demand adjustment factor for solar generation.

In a more particular example, supply capacity manager 2110 can calculate the following:

Hourly solar forecast for the community=Hourly solar generation forecast x Solar generation scale down factor

Number of solar shares available for subscription=Solar capacity/Share size configuration for solar

Solar share unit price=(Solar capacity x Cost configuration for solar)/Number of solar shares available for subscription

Number of battery shares available for subscription=Battery capacity/Share size configuration for battery

Battery share unit price=(Battery capacity x Cost configuration for battery)/Number of battery shares available for subscription

As described above, the hourly solar and battery capacity information, number of units available for subscription, and/or the unit price for solar and/or battery shares can be transmitted to an electronic billing system and/or a subscription manager. For example, the electronic billing system can recommend that a residential user purchase a particular number of solar and/or battery shares. In another example, the subscription manager can share subscription status information regarding the number of purchased solar and/or battery shares to the electronic billing system.

### Overall System

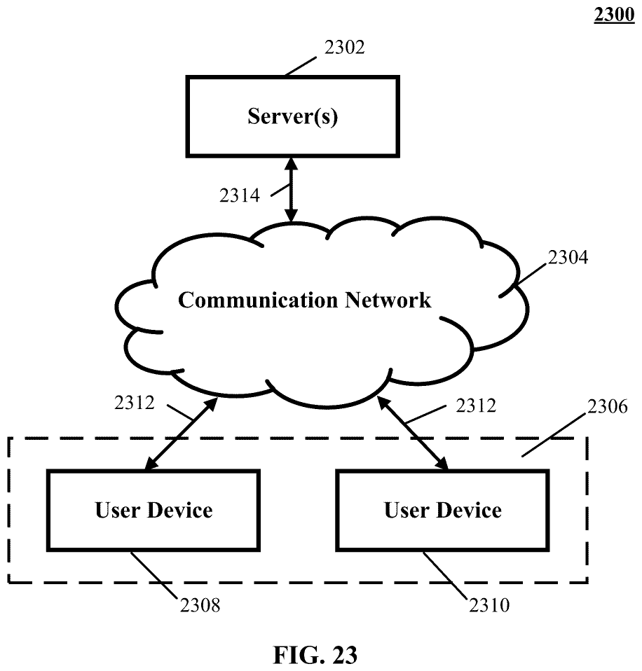

Turning to FIG. 23, an illustrative example 2300 of hardware for energy management that can be used in accordance with some embodiments of the disclosed subject matter is shown. As illustrated, hardware 2300 can include a server 2302, a communication network 2304, and/or one or more user devices 2306, such as user devices 2308 and 2310.

Server 2302 can be any suitable server(s) for storing information, data, programs, and/or any other suitable content. For example, in some embodiments, server 2302 can store any suitable energy data, such as information from energy-related sensors in a building (e.g., thermostat devices, lighting devices, automated window shade devices, heating systems, cooling systems, ventilation systems, etc.), information from external data sources (e.g., weather information, electricity grid pricing information, etc.), etc. In some embodiments, server 2302 can execute any suitable functions for energy management of a building. For example, as described above in connection with FIG. 2, server 2302 can determine that a device is eligible for automatic control and can determine whether to transmit an automated control action based on a dynamic rate, budget information, and solar and battery information. In another example, as described above in connection with FIG. 2, server 2303 can determine that a device that a device is not eligible for automatic control and can determine whether to transmit a recommendation to a mobile application of a residential user that prompts the user to manually control a device based on a dynamic rate, budget information, and solar and battery information. In yet another example, server 2303 can dynamically determine an energy price based on the changing wholesale price of electricity and based on a capacity cost that is proportional with network demand. In a further example, server 2303 can generate a customized bill for the residential user and/or recommend that the residential user purchase a particular number of solar and/or battery shares.

Communication network 2304 can be any suitable combination of one or more wired and/or wireless networks in some embodiments. For example, communication network 2304 can include any one or more of the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network. User devices 2306 can be connected by one or more communications links (e.g., communications links 2312) to communication network 2304 that can be linked via one or more communications links (e.g., communications links 2314) to server 2302. The communications links can be any communications links suitable for communicating data among user devices 2306 and server 2302 such as network links, dial-up links, wireless links, hard-wired links, any other suitable communications links, or any suitable combination of such links.

User devices 2306 can include any one or more user devices suitable for detecting the presence of devices and/or sensors within a building, communicating building data, presenting user interfaces for initiating adjustments to the operation of one or more devices in a building, etc.

For example, in some embodiments, user devices 2306 can include one or more residential devices 2308. Examples of residential devices can include appliances (e.g., a refrigerator, a washer/dryer, a dishwasher, a fan, and/or any other suitable devices), a heating system, a cooling system, a ventilation system, a lighting device, a camera or imaging device (e.g., an outdoor camera, an infrared imaging device, a thermal imaging device, a LIDAR imaging device, etc.), a display device, a mobile device, a gaming device, and/or a communications device (e.g., a gateway, a Wi-Fi access point, a wireless backhaul system, etc.).

In another example, in some embodiments, user devices 2306 can include one or more sensor devices 2310. Examples of sensor devices can include an air quality sensing device, a temperature sensing device, a pressure sensing device, a sound or noise sensing device, a light sensing device, a humidity sensing device, an occupancy sensing device, etc.

Although server 2302 is illustrated as one device, the functions performed by server 2302 can be performed using any suitable number of devices in some embodiments. For example, in some embodiments, multiple devices can be used to implement the functions performed by server 2302. In a more particular example, a first server can provide scheduler features that autonomously manages energy-consuming systems and devices in a home of a residential user based on a comfort mode, energy budget, and solar and/or battery shares, a second server can provide dynamic rate engine features that dynamically determine an energy price based on the changing wholesale price of electricity and based on a capacity cost that is proportional with network demand, a third server can provide electronic billing system features that interface with the home scheduler system and the dynamic rate engine to generate a customized bill for the residential user, and a fourth server can provide a solar and battery transaction system features for recommending whether to purchase solar and/or battery shares to offset the price of electricity during times of peak demand.

Although two user devices 2308 and 2310 are shown in FIG. 23 to avoid over-complicating the figure, any suitable number of user devices, and/or any suitable types of user devices, can be used in some embodiments.

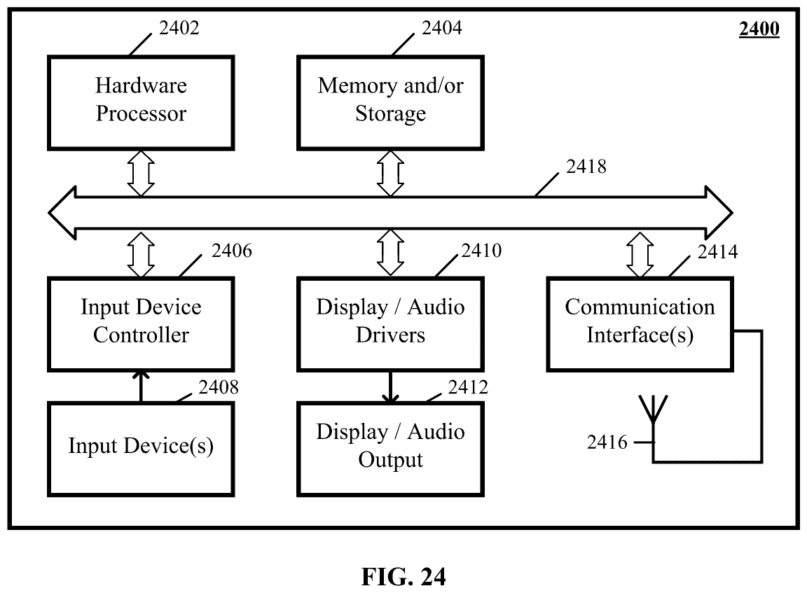

Server 2302 and user devices 2306 can be implemented using any suitable hardware in some embodiments. For example, in some embodiments, devices 2302 and 2306 can be implemented using any suitable general purpose computer or special purpose computer. For example, a mobile phone may be implemented using a special purpose computer. Any such general purpose computer or special purpose computer can include any suitable hardware. For example, as illustrated in example hardware 2400 of FIG. 24, such hardware can include hardware processor 2402, memory and/or storage 2404, an input device controller 2406, an input device 2408, display/audio drivers 2410, display and audio output circuitry 2412, communication interface(s) 2414, an antenna 2416, and a bus 2418.

Hardware processor 2402 can include any suitable hardware processor, such as a microprocessor, a micro-controller, digital signal processor(s), dedicated logic, and/or any other suitable circuitry for controlling the functioning of a general purpose computer or a special purpose computer in some embodiments. In some embodiments, hardware processor 2402 can be controlled by a server program stored in memory and/or storage of a server, such as server 2302. In some embodiments, hardware processor 2402 can be controlled by a computer program stored in memory and/or storage 2404 of user device 2306.

Memory and/or storage 2404 can be any suitable memory and/or storage for storing programs, data, and/or any other suitable information in some embodiments. For example, memory and/or storage 2404 can include random access memory, read-only memory, flash memory, hard disk storage, optical media, and/or any other suitable memory.

Input device controller 2406 can be any suitable circuitry for controlling and receiving input from one or more input devices 2408 in some embodiments. For example, input device controller 2406 can be circuitry for receiving input from a touchscreen, from a keyboard, from one or more buttons, from a voice recognition circuit, from a microphone, from a camera, from an optical sensor, from an accelerometer, from a temperature sensor, from a near field sensor, from a pressure sensor, from an encoder, and/or any other type of input device.

Display/audio drivers 2410 can be any suitable circuitry for controlling and driving output to one or more display/audio output devices 2412 in some embodiments. For example, display/audio drivers 2410 can be circuitry for driving a touchscreen, a flat-panel display, a cathode ray tube display, a projector, a speaker or speakers, and/or any other suitable display and/or presentation devices.

Communication interface(s) 2414 can be any suitable circuitry for interfacing with one or more communication networks (e.g., computer network 2304). For example, interface(s) 2414 can include network interface card circuitry, wireless communication circuitry, and/or any other suitable type of communication network circuitry.

Antenna 2416 can be any suitable one or more antennas for wirelessly communicating with a communication network (e.g., communication network 2304) in some embodiments. In some embodiments, antenna 2416 can be omitted.

Bus 2418 can be any suitable mechanism for communicating between two or more components 2402, 2404, 2406, 2410, and 2414 in some embodiments.

Any other suitable components can be included in hardware 2400 in accordance with some embodiments.

In some embodiments, at least some of the above described blocks of the processes of FIGS. 2-5, 14, 16, 21, and 22 can be executed or performed in any order or sequence not limited to the order and sequence shown in and described in connection with the figures. Also, some of the above blocks of FIGS. 2-5, 14, 16, 21, and 22 can be executed or performed substantially simultaneously where appropriate or in parallel to reduce latency and processing times. Additionally or alternatively, some of the above described blocks of the processes of FIGS. 2-5, 14, 16, 21, and 22 can be omitted.

In some embodiments, any suitable computer readable media can be used for storing instructions for performing the functions and/or processes herein. For example, in some embodiments, computer readable media can be transitory or non-transitory. For example, non-transitory computer readable media can include media such as non-transitory forms of magnetic media (such as hard disks, floppy disks, and/or any other suitable magnetic media), non-transitory forms of optical media (such as compact discs, digital video discs, Blu-ray discs, and/or any other suitable optical media), non-transitory forms of semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

In situations in which the systems described herein collect personal information about users, or make use of personal information, the users may be provided with an opportunity to control whether programs or features collect user information (e.g., information about a user's social network, social actions or activities, profession, a user's preferences, or a user's current location). In addition, certain data may be treated in one or more ways before it is stored or used, so that personal information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Accordingly, methods, systems, and media for automatic and continuous control of energy-consuming devices are provided.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A method for energy management, the method comprising:
determining, using a hardware processor, connected devices from a plurality of devices that are eligible for automatic control, wherein the plurality of devices are connected to a communications network;
determining, using the hardware processor, available actions for each of the connected devices;
generating, using the hardware processor, a plurality of automatic control actions for at least a portion of the connected devices based at least in part on a dynamic rate of electricity generated by a dynamic rate engine and an energy mode selected by a user in an application, wherein the plurality of automatic control actions are based on the available actions for each connected device;
causing, using the hardware processor, a user interface to be presented in an application that indicates the plurality of automatic control actions for transmission to the portion of the connected devices, wherein the user interface provides a user interface element for overriding one or more of the plurality of automatic control actions;
in response to determining that the user interface element for overriding one or more of the plurality of automatic control actions has not been selected by the user of the application, transmitting, using the hardware processor, a first subset of the plurality of automatic control actions to one or more communication gateways that are each connected to at least one of the subset of connected devices and a second subset of the plurality of automatic control actions directly to a subset of the connected devices via a device cloud platform; and
updating, using the hardware processor, the user interface to indicate that at least one of the first subset of the plurality of automatic control actions and the second subset of the plurality of automatic control actions have been performed on the portion of the connected devices and energy usage savings from the performance of the automatic control actions.

2. The method of claim 1, wherein the subset of connected devices is determined to be eligible for automatic control based on an operation mode selected by the user in the application and based on a device status associated with each of the plurality of devices.

3. The method of claim 1, wherein the subset of connected devices is determined to be eligible for automatic control by comparing the dynamic rate of electricity generated by the dynamic rate engine with a threshold value.

4. The method of claim 1, wherein the subset of connected devices is determined to be eligible for automatic control based on user preferences that have been inputted by the user into the application. The method of claim 1, wherein the subset of connected devices is determined to be eligible for automatic control based on user preferences that have been learned by a machine learning model associated with the application.

6. The method of claim 1, wherein the subset of connected devices is determined to be eligible for automatic control based on the energy mode selected by the user in the application and based on a comparison of energy usage for a particular time period with a target budget that is associated with the selected energy mode.

7. The method of claim 1, wherein the subset of connected devices is determined to be eligible for automatic control based on an availability of community solar and battery shares.

8. The method of claim 1, wherein the dynamic rate of electricity is generated based on the availability of community solar and battery shares.

9. The method of claim 1, wherein the subset of connected devices is determined to be eligible for automatic control based on a comparison of an actual and forecasted electricity cost for a particular time period with a target budget for the particular time period.

10. The method of claim 1, wherein the subset of connected devices is determined to be eligible for automatic control based on the number of device control actions issued for each of the subset of connected devices.

11. The method of claim 1, wherein the dynamic rate engine determines the dynamic rate to incorporate a commodity cost, a transmission, distribution, and administration cost, and a settlement cost, wherein the commodity cost is determined at a particular time interval and is based on historical market data, weather forecast data, and machine learning predictions of energy consumption estimates for each time interval, wherein the transmission, distribution, and administration cost is a share of a total forecasted transmission, distribution, and administration cost for a utility provider, weighted based on forecasted electricity demand for the community, and wherein the settlement cost is proportional to forecasted energy demands for a community that includes the user.

12. The method of claim 1, wherein the plurality of devices are located within a residential home and wherein the method further comprises determining whether the residential home is vacant based on current occupancy information and historical occupancy information.

13. The method of claim 12, further comprising determining whether the residential home is vacant based on a vacancy confidence, wherein vacancy confidence level is incrementally increased over time until occupancy of the residential home from the current occupancy information has been confirmed.

14. The method of claim 13, further comprising performing a vacancy check in response to determining that the vacancy confidence level has met an actionable vacancy confidence threshold value.

15. The method of claim 14, further comprising retrieving an expectation of occupancy value for a current time from a learned occupancy schedule and comparing the expectation of occupancy value for the current time from the learned occupancy schedule against the actionable vacancy confidence threshold value.

16. The method of claim 12, wherein the current occupancy information is captured using an occupancy sensor that is associated with one of the connected devices.

17. The method of claim 12, wherein the current occupancy information is captured based on one or more user interactions with one of the connected devices.

18. The method of claim 12, wherein the current occupancy information is determined at least in part by transmitting energy usage information into a machine learning system that identifies changes in power consumption that correspond to occupancy of the residential home.

19. A system for energy management, the system comprising:
a hardware processor that is configured to:
determine connected devices from a plurality of devices that are eligible for automatic control, wherein the plurality of devices are connected to a communications network;
determine available actions for each of the connected devices;
generate a plurality of automatic control actions for at least a portion of the connected devices based at least in part on a dynamic rate of electricity generated by a dynamic rate engine and an energy mode selected by a user in an application, wherein the plurality of automatic control actions are based on the available actions for each connected device;
cause a user interface to be presented in an application that indicates the plurality of automatic control actions for transmission to the portion of the connected devices, wherein the user interface provides a user interface element for overriding one or more of the plurality of automatic control actions;
in response to determining that the user interface element for overriding one or more of the plurality of automatic control actions has not been selected by the user of the application, transmit a first subset of the plurality of automatic control actions to one or more communication gateways that are each connected to at least one of the subset of connected devices and a second subset of the plurality of automatic control actions directly to a subset of the connected devices via a device cloud platform; and
update the user interface to indicate that at least one of the first subset of the plurality of automatic control actions and the second subset of the plurality of automatic control actions have been performed on the portion of the connected devices and energy usage savings from the performance of the automatic control actions.

20. A non-transitory computer-readable medium containing computer executable instructions that, when executed by a processor, cause the processor to perform a method for energy management, the method comprising:
determining, using a hardware processor, connected devices from a plurality of devices that are eligible for automatic control, wherein the plurality of devices are connected to a communications network;
determining, using the hardware processor, available actions for each of the connected devices;
generating, using the hardware processor, a plurality of automatic control actions for at least a portion of the connected devices based at least in part on a dynamic rate of electricity generated by a dynamic rate engine and an energy mode selected by a user in an application, wherein the plurality of automatic control actions are based on the available actions for each connected device;
causing, using the hardware processor, a user interface to be presented in an application that indicates the plurality of automatic control actions for transmission to the portion of the connected devices, wherein the user interface provides a user interface element for overriding one or more of the plurality of automatic control actions;
in response to determining that the user interface element for overriding one or more of the plurality of automatic control actions has not been selected by the user of the application, transmitting, using the hardware processor, a first subset of the plurality of automatic control actions to one or more communication gateways that are each connected to at least one of the subset of connected devices and a second subset of the plurality of automatic control actions directly to a subset of the connected devices via a device cloud platform; and
updating, using the hardware processor, the user interface to indicate that at least one of the first subset of the plurality of automatic control actions and the second subset of the plurality of automatic control actions have been performed on the portion of the connected devices and energy usage savings from the performance of the automatic control actions.
